(19) United States
(12) Patent Application Publication
(10) Pub. No.: US 2026/0032147 A1
(43) Pub. Date: Jan. 29, 2026

(54) ANTI-HAMMERING MECHANISM IN A NETWORK SERVER

(71) Applicant: MELLANOX TECHNOLOGIES, LTD., Yokneam (IL)

(72) Inventors: Ahmed Atamli, Brighton (GB); Noam Bloch, Bat Shlomo (IL); Miriam Menes, Tel Aviv (IL); Yamin Friedman, Jerusalem (IL)

(21) Appl. No.: 19/041,170

(22) Filed: Jan. 30, 2025

(30) Foreign Application Priority Data
Jul. 28, 2024 (IL) 314589

(51) Int. Cl. H04L 9/40

(52) U.S. Cl. CPC H04L 63/1441; H04L 63/1416

(57) ABSTRACT

Embodiments disclosed relate to performing threat detection in networks, as may include detecting and responding to hammer attacks in RDMA or other such networks. In an RDMA network, a server or a process may authenticate requests by verifying if the key presented matches one that is pre-shared with another server or process. Such a system can enhance security by incorporating a counter mechanism that tracks number of requests with unmatched information. Upon detecting that the count of such requests surpasses a predefined threshold, the system may determine that this is indicative of a potential hammer attack and may perform various actions in response. For example, an alert may be triggered and sent to a host. The host, upon receiving this alert, may temporarily disable the server or identify the source of these suspicious requests and enable the host to take targeted action, such as blocking the attacker to prevent further unauthorized attempts.

### CROSS-REFERENCE TO RELATED APPLICATIONS

This application claims priority to Israeli Application Serial No. 314,589, filed Jul. 28, 2024, and entitled “Anti-Hammering Mechanism in a Network Server”, which is hereby incorporated herein in its entirety for all purposes.

### TECHNICAL FIELD

At least one embodiment pertains to detecting and preventing an attack on a networked system.

### BACKGROUND

There are various technologies that can be used in networked computing systems to provide access to, for example, computer memory. One such technology—Remote Direct Memory Access (RDMA)—is designed to enhance the efficiency and speed of network communication. RDMA allows direct memory access from the memory of one node to another without involving the operating systems of both nodes. This capability significantly reduces latency and CPU overhead. RDMA is widely used in high-performance computing, data centers, and cloud computing, as it significantly reduces latency and offloads CPU usage. However, the integration of technologies such as RDMA in client-server architectures may bring network security challenges. As one example, the bypassing of traditional operating system-level security checks can leave systems more vulnerable to unauthorized access.

### BRIEF DESCRIPTION OF THE DRAWINGS

Various embodiments in accordance with the present disclosure will be described with reference to the drawings, in which:

FIG. 1 illustrates an example network connected by a channel-based fabric, in accordance with various embodiments;

FIG. 2 illustrates an example RDMA network with a threat detection and prevention mechanism, in accordance with various embodiments;

FIG. 3 illustrates example functionalities provided by a threat detection and prevention system, in accordance with various embodiments;

FIG. 4 illustrates an example global threat detection system, in accordance with various embodiments;

FIG. 5 illustrates an exemplary process for performing threat detection and prevention, in accordance with various embodiments;

FIG. 6 illustrates an example data center system, according to at least one embodiment;

FIG. 7 is a block diagram illustrating a computer system, according to at least one embodiment;

FIG. 8 is a block diagram illustrating a computer system, according to at least one embodiment;

FIG. 9 illustrates a computer system, according to at least one embodiment;

FIG. 10 illustrates a computer system, according to at least one embodiment;

FIG. 11 illustrates exemplary integrated circuits and associated graphics processors, according to at least one embodiment;

FIGS. 12A, 12B illustrate exemplary integrated circuits and associated graphics processors, according to at least one embodiment;

FIGS. 13A, 13B illustrate additional exemplary graphics processor logic according to at least one embodiment;

FIG. 14 illustrates a computer system, according to at least one embodiment;

FIG. 15A illustrates a parallel processor, according to at least one embodiment;

FIG. 15B illustrates a partition unit, according to at least one embodiment;

FIG. 15C illustrates a processing cluster, according to at least one embodiment;

FIG. 15D illustrates a graphics multiprocessor, according to at least one embodiment;

FIG. 16 illustrates a multi-graphics processing unit (GPU) system, according to at least one embodiment;

FIG. 17 illustrates a graphics processor, according to at least one embodiment; and

FIG. 18 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments disclosed relate to performing threat detection in computer networks. Specifically, at least some embodiments disclosed herein relate to detecting and responding to attacks in networks using a communication or access technology such as Remote Direct Memory Access (RDMA). These attacks may include hammer attacks, which may correspond to aggressive attempts by an attacker (or may also be referred to as an actor, which may refer to any network entity, computing entity, a bot, or a person) to gain unauthorized access to at least one computing resource (such as a server) through the persistent “guessing” of sensitive information, where the guessing can include submitting a large number of attempts including different potential values of the sensitive information. In an RDMA network, for example, such sensitive information may correspond to a key (or other information such as Queue Pair Number, Packet Sequence Number, or virtual address) embedded within requests. In one embodiment, a key may also be referred to as an access key, which is a security credential used to authenticate and/or authorize access to various systems in a network. In an RDMA network, a server or a process may authenticate requests by verifying whether a key or other sensitive information presented matches a valid key or other sensitive information that was previously shared with another server or process. Such approaches to threat detection can enhance security by, for example, incorporating a counter mechanism that tracks number of requests with keys or sensitive information that differ from the expected, valid values. Upon detecting that the count of such requests (or calls, submissions, etc.) surpasses a predefined threshold, or satisfies another such security criterion, a system may determine that the volume of requests with invalid keys or sensitive information is indicative of a potential hammer attack, and may perform any of a number of actions in response. For example, an alert may be triggered and sent to a host. The host, upon receiving this alert, may have multiple response options. Another approach may temporarily disable the server from receiving any further requests for a period of time, or may block requests from an address or range of addresses associated with the suspicious requests. In one embodiment, a detection system can identify the source of these suspicious requests and enable the host to take targeted actions, such as blocking the attacker to prevent further unauthorized attempts. In one embodiment, a detection system can rekey and/or reconfigure the access key to reduce the risk of key compromise. A threat detection system integrated into such a network can monitor request authenticity and provide a robust defense mechanism for these networks against potential threats.

A system in accordance with at least one embodiment may provide several technical advantages and improvements. For example, such a threat detection system offers an enhancement in network security by effectively identifying and responding to potential attacks. By allowing direct memory access from one computer to another (e.g., bypassing the operating system), for example, networks such as RDMA networks offer high-speed and low-latency data transfer. It should be understood that while RDMA is discussed as a primary example herein, there may be other technologies known or subsequently developed that may perform at least some similar functionality and could benefit from aspects of the various embodiments as presented herein. Such efficiency, however, can come with inherent security vulnerabilities. For example, since RDMA operations bypass the usual safety checks of operating systems, nodes in RDMA networks may become potential targets for specific types of cyber-attacks, such as hammer attacks where attackers can persistently try to guess and exploit sensitive information. Existing structures of RDMA networks lack robust mechanisms to identify and detect such threats and expose applications that rely on RDMA networks to significant risks. An example approach to threat detection can address this critical issue by providing a threat detection mechanism for networks, such as RDMA networks. Threat detection can be achieved in at least one embodiment by monitoring for unusual patterns, such as repeated unauthorized access attempts, and alerting the hosts when such patterns are detected. An example threat detection system may provide immediate and targeted responses, such as blocking the attacker or temporarily disabling entities of the network that are under potential threat.

Moreover, such approaches can protect cyber security without undermining the high-speed and low-latency benefits of RDMA networks. For example, a threat detection system can detect potential hammer attacks without compromising the inherent efficiency of RDMA networks. Traditional methods of enhancing cybersecurity in network systems may involve encryption and decryption, which, while effective, may involve operations that go through the operating systems or kernels. Such security mechanisms involving CPU operations may undermine advantages of RDMA networks. As a result, RDMA networks, whose primary advantages lie in their high-speed and low-latency capabilities without accessing the operating system, may benefit from specialized cybersecurity mechanisms designed based on their unique architecture. An example approach to threat detection can resolve this and other such issues by, at least in part, implementing a specialized mechanism designed to detect and identify potential threats in RDMA networks. By employing a monitoring mechanism that tracks the number of requests with unmatched information, a threat detection system can identify potential threats. When the count of such requests exceeds a predefined threshold, a system may determine a potential hammer attack and may trigger an alert. Such monitoring can enable timely responses and, therefore, may improve the overall security of RDMA networks and reduce the risk of successful unauthorized access. As a result, such an approach to threat detection system can provide an effective solution that safeguards the network against cyber threats while preserving the advantages of speed and low latency that are offered by networks, such as RDMA networks.

Variations of this and other such functionality can be used as well within the scope of the various embodiments as would be apparent to one of ordinary skill in the art in light of the teachings and suggestions contained herein.

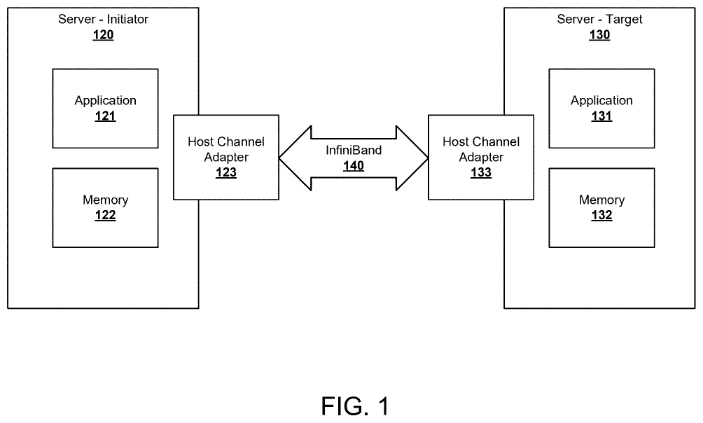

FIG. 1 illustrates an example switched fabric communications network, in accordance with an embodiment. Such a network may utilize a switched fabric that uses the InfiniBand network communications standard to provide for high throughput and low latency, often used with high performance computing (HPC) operations. Other communication fabrics or connectors can be used as well within the scope of the various embodiments. In at least one embodiment, such a network may be an RDMA network that includes two servers, an initiator 120 and a target 130, connected via an InfiniBand network 140. The initiator server 120 and the target server 130 may comprise one or more processes that involve the operations of sending and receiving requests for communicating with other servers or processes in the network. A Host Channel Adapter (HCA) 123 within the initiator server may facilitate the connection to the InfiniBand network 140. An HCA is a hardware component in a high-performance computing environment that utilizes RDMA technology. An HCA, such as HCA 123 or HCA 133, may serve as an interface between, for example, a server and an RDMA network. HCAs may be responsible for managing direct memory access operations that allow data to be transferred directly from the memory of one node to another without the need for intermediary data buffering by the CPU, operating system, or software layers. To manage outbound and inbound communications, an HCA may utilize Queue Pairs (QPs), with each pair consisting of a Send Queue and a Receive Queue. In one embodiment, a network as illustrated in FIG. 1 may be a dynamically-connected (DC) network that involves dynamically-connected Queue Pairs (DCQPs). DCQPs may extend the capabilities of standard RDMA by allowing queue pairs to dynamically connect and disconnect to different nodes in a network.

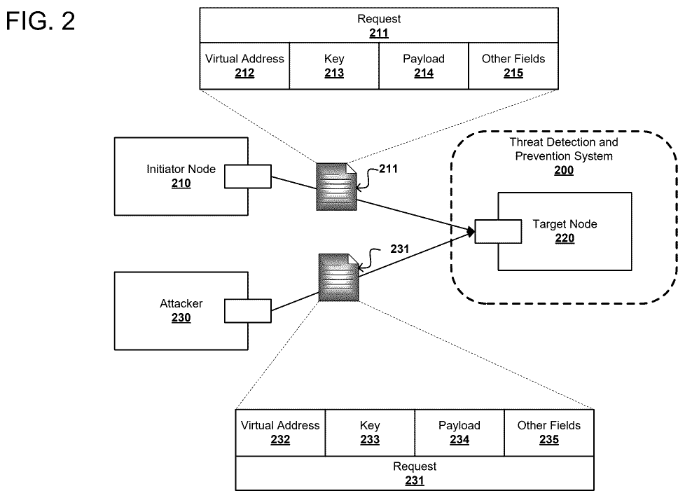

A network such as an InfiniBand network 140 may act as a communication channel that supports high-speed data transfers with reduced latency. A communication standard such as InfiniBand can define how data is to be transmitted over a network. Such an approach can be implemented using a switched fabric network topology, such that the devices are interconnected in a way that allows data to take multiple paths to reach its destination. A target server 130 may also comprise a Host Channel Adapter 133 that connects the server to the InfiniBand network 140. As an example, an application 121 of this initiator server 120 may create a Work Request (WR) to send data to a target server 130 (e.g., application 131 of target server 130). This work request may contain information, such as an access key, the size of the data, a memory address in initiator server 120, a location where the data is located, and the destination memory address in target server 130. This work request is posted to the Send Queue HCA 133 of initiator server 120. The HCA 133 may take this work request and handle the data transfer directly from memory 122 of initiator server 120 to memory 132 of target server 130 without CPU involvement. Concurrently, target server 130 may have a work request posted to its Receive Queue in anticipation of the incoming data. This HCA 133 can be configured to match the incoming data transfer requests with the appropriate memory addresses where the data should be placed. As the data arrives at target server 130, the HCA 133 may complete the operation by writing the data to the specified location in memory 132 of target server 130. This operation happens with reduced latency because the data transfer bypasses the CPUs of both. In one embodiment, information carried in fields of such a request, such as fields—access key, destination memory address, and other identities—may need to match the information previously communicated with the target server in order for the request to be processed. An attacker may attempt to guess such sensitive information to get unauthorized access to the target server. An example system with an attacker and a threat detection system that can prevent such attacks are discussed in accordance with FIG. 2.

FIG. 2 illustrates an example system 200 that can provide for threat detection and prevention, in accordance with one embodiment. The example system illustrated in FIG. 2 includes an initiator node 210 and a target node 220, where a node may be any appropriate computing or processing device connected to a network, which can include servers, personal computers, phones, or other networking devices. In this example, an initiator node 210 may initiate a transaction by sending a request 211 to a target node 220. In this example, an attacker 230 may attempt to brute force sensitive information in order to access data in a target node 220. An example threat detection and prevention system 200 can attempt to detect and/or identify potential threats such as suspicious or malicious actions performed by the attacker 230. Individual components are discussed in further detail below.

In one embodiment, an initiator node 210 and an attacker 230 may both send requests (e.g., requests 211 and 231) to access the target node 220. These requests 211, 231 may be of a specific format. For example, a first request 211 may include a virtual address 212 that indicates the destination memory location for the operation. In a standard RDMA transaction such as the one between node 210 and node 220, an HCA may begin by allocating a memory region, which involves copying the relevant page table entries to its memory management unit. The HCA may then define a memory region, with each memory region associated with a local key (may also be referred to as lkey) for host operations and/or a remote key (may also be referred to as rkey) for remote operations. During an RDMA read or write operation, a packet is sent including the virtual address 212 and the key information 213. This key 213 may act as an access token, which is transmitted in plaintext and is not used for encryption. This request 211 may further include a payload 214 containing the data to be transferred, and other fields 215, such as QP (Queue Pair) identifiers, message IDs, or flags for the operation. The key 213 may serve as an access token that allows a remote node to perform the operations it authorizes, like reading or writing data, as long as it adheres to the access permissions set for that memory region. In one embodiment, any request that includes the correct remote key (may also be referred to as rkey) and virtual address can potentially perform operations on the target memory region. In one embodiment, during the initialization phase of a connection, nodes such as 210 and 220 may exchange access keys via a secure channel established through a Connection Management Protocol (CMP). These keys may be generated when the host's memory regions are registered with the HCA. The keys are then shared with the intended remote node which enables it to perform authorized operations on the memory region. This mechanism may ensure that both nodes possess the necessary authorization tokens prior to any RDMA operations.

The example illustrated in FIG. 2 may also include a potential security threat such as an attacker 230 who tries to gain access to target node 220 using an unauthorized approach. As the key information such as key 213 is pre-shared with authorized parties, this key is not available to outside entities. Therefore, an adversary such as an attacker 230 may attempt to gain access to the memory of a given target node 220 by guessing the key information. The attacker 230 may utilize a strategy that repeatedly guesses and presents a guessed key 233 to target node 220. For example, in one attempt, the guessed key 233 may not match the key information such as a valid key 213 which was pre-shared between node 210 and node 220. Presenting an unmatched key may result in denial of access to target node 220. The attacker 230 may persistently engage in multiple access attempts presenting varying guessed keys. With repeated trials, the probability of the attacker 230 successfully deciphering the correct key increases, which may potentially lead to unauthorized access to target node 220. Existing network structures such as RDMA networks may lack a mechanism to effectively identify and prevent such unauthorized attempts. However, a threat detection and prevention system 200 may detect and prevent such threats.

In this example, a threat detection and prevention system 200 may monitor and keep track of requests with unmatched information. Such a system may differentiate between naïve errors and patterns indicative of a security threat. For example, an occasional access request with incorrect information could be attributed to a naïve mistake. A threat detection and prevention system 200 is designed to recognize and respond to an accumulating number of requests with mismatched information. Such a system may identify suspicious patterns, such as recognizing that a surge in access attempts with mismatched information could signal an attempt at unauthorized access. Once the frequency of these mismatched requests surpasses a predefined threshold, the system may escalate its response and activate measures to prevent potential security breaches. In one embodiment, such a threat detection system is implemented at the hardware level across various networking devices like adapters and network switches. For example, such a mechanism may be implemented at data processing units (DPUs) and network accelerators (e.g., SuperNIC (Network Interface Card) and BlueField series).

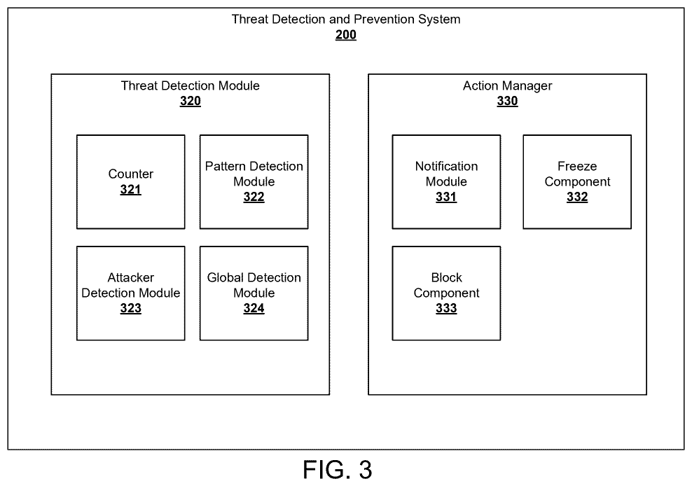

In one embodiment, such a threat detection system may protect against potential threats in a Dynamically Connected transport service. A Dynamically Connected (DC) transport may provide transport services from a DC Initiator (DCI) to a DC Target (DCT) (e.g., initiator node 210 to target node 220). A DCI can send data to multiple targets on the same or different subnet, and a DCT can simultaneously service traffic from multiple DCIs. A target DCT may be identified by values associated with one or more fields that are included in request 211. For example, these fields may include one or more of an address vector that specifies the network details of the target, such as its network and queue pair address (e.g., virtual address 212), a DCT number that uniquely identifies the DC Target (DCT) within the RDMA network, and a DC access key which ensures that only authorized initiators can access the target's memory (e.g., key 213), operation type that indicates e type of operation being requested, such as RDMA read or write, etc. If an initiator sends a request with values of the fields (such as virtual address 232, key 233, payload 234, and other fields 235) matching what was previously shared with the target node, access to the target node may be granted. An attacker may attempt to repeatedly guess values of one or more of these fields, which may potentially lead to unauthorized access to target node. A threat detection and prevention system 200 may identify and prevent such potential risks. Threat detection and prevention system 200 is discussed in further detail in accordance with FIG. 3.

FIG. 3 is an example block diagram illustrating modules or functionalities useful for threat detection and prevention, as may be implemented using a threat detection and prevention system 200 as discussed with respect to FIG. 2. Upon receiving a request from an initiator server or a dynamically connected initiator (DCI), for example, an HCA of a target server or a dynamically connected target (DCT) may perform various tasks associated with a threat detection module 320. In one embodiment, a threat detection module 320 may use a counter 321, which logs incoming requests with mismatched information. For example, upon receiving a request with mismatched key information (or mismatched information in other fields), the corresponding HCA may increment the count of a counter 321. If the count exceeds a predefined threshold, the threat detection module 320 may contact an action manager 330, or other such system, component, or process, which can determine one or more actions to be taken to prevent or mitigate a potential attack or other undesired occurrence. For example, the action manager 330, upon being notified that the count exceeds a predetermined threshold, may contact a notification module 331 that can notify the target server. To safeguard the node from subsequent intrusion attempts, the target server may contact a freeze component 332 to at least temporarily disable or freeze the node for a specified duration.

The threat detection module 320 may also involve a pattern detection module 322 that may leverage algorithms to determine potential threats by analyzing patterns of incoming network requests. For example, the pattern detection module 322 may identify a pattern of repeated login attempts originating from a single IP address or a range of IP addresses, with the attempts targeting one or several accounts. These requests might be characterized by rapid submission frequency and varying key inputs/guesses (or guesses associated with other fields). Upon detection, the threat detection and prevention system 200 can alert the host server (e.g., target node 220 in FIG. 2), which could then temporarily lock or freeze the target node and block or rate-limit incoming requests from the identified addresses/nodes by contacting the freeze component 332. For example, a threat detection and prevention system may utilize algorithms to analyze the patterns of incoming requests, which may involve using heuristic methods or machine learning techniques to differentiate between normal network traffic and patterns that are indicative of a security threat. For example, a detection of repeated, persistent access attempts with varying keys may be indicative of a potential attack. In one embodiment, the threat detection and prevention system 200 is configured to identify and respond to anomalies in network activity. For example, the threat detection and prevention system 200 may detect sudden spikes in request rates or unusual patterns in the types of requests being made via the pattern detection module 322 and determine that a potential hammer attack is occurring. In such scenarios, the unusual pattern may be sent to the host to notify the host that a potential hammer attacker may be happening. The host server may then take protective measures such as temporarily freezing or disabling the host via a freeze component 332. In one embodiment, the pattern detection module 322 may also involve analyzing key input patterns to identify identical or similar key input patterns and determine them. If several mismatched key inputs are associated with a similar pattern (e.g., based on a determination by a machine learning algorithm), it may be determined that host server is at potential risk of a hammer attack.

The threat detection module 320 may also associate incoming requests with mismatched information with one or more potential attackers via an attacker detection module 323, in accordance with one embodiment. When multiple access attempts with mismatched keys are received from a single sender identifier, a threat detection module 320 may start tracking these attempts. Examples of identifiers may include but are not limited to IP addresses, InfiniBand Addresses in an InfiniBand network, or IP over InfiniBand (IPoIB) identifiers in networks combining IP and InfiniBand technologies. For efficient tracking and analysis, a threat detection module 320 may temporarily store information about each sender of mismatched requests. This may include maintaining a detailed log that records counts of mismatched requests for each sender identifier. The log is designed to keep track of these counts over a predefined period which allows the system to identify patterns and potential security threats over time. For example, the target server may keep a log with counts of requests with mismatched information for each sender identifier for a period of time. If the count of such mismatched requests from a sender identifier exceeds a predefined limit within a set time frame, it may be indicative of a potential hammer attack. If a sender is associated with a suspicious number of requests with mismatched information, the action manager 330 may perform actions on the respective attacker. For example, the action manager 330 may then block, via a block component 333, further requests associated with this sender identifier for a specified duration.

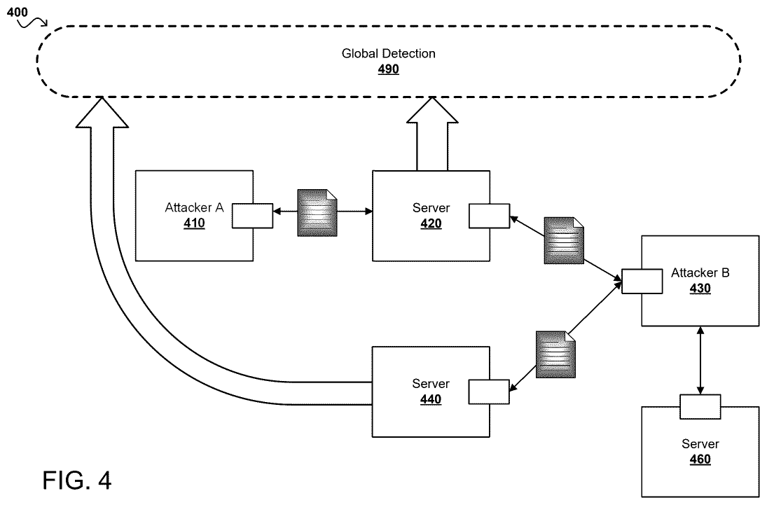

In one embodiment, the threat detection module 320 may include a global detection module 324 that monitors mismatched requests within a network. For example, the global detection module 324 may involve monitoring mismatched requests throughout an entire RDMA network. Unlike local detection systems that operate at individual nodes or segments of the network, a global detection module 324 may monitor activities across the entire network infrastructure. The global detection module 324 may aggregate data from various network adapters and nodes, which may include collecting information from different network adapters and nodes. Each endpoint in the network may gather data, such as details of access attempts (both successful and failed), traffic volume, patterns of data flow, and other relevant metrics, and report to the global detection module 324. In one embodiment, the global detection module 324 may deploy software capable of analyzing traffic and access patterns in real-time and identifying potential security threats, such as repeated unauthorized access attempts, unusual traffic surges, or patterns indicative of cyber-attacks like DoS (denial of service), hammer attacks, or intrusion attempts. In one embodiment, while individual network adapters in a network such as an RDMA network are not primarily responsible for monitoring activities, they may be configured to transmit pertinent data to a centralized detection system. This may include detailed logs of access attempts, both normal and anomalous, and quantitative data on traffic volume and types. Based on the analysis, the action manager 330 may perform respective actions, such as but are not limited to: generating alerts via a notification module 331 to network administrators, blocking or restricting suspicious traffic via a freeze component 332, rerouting data flows to mitigate potential attacks, or temporarily blocking future requests from a suspicious sender ID. An example embodiment of a global detection module 324 is discussed in further detail in accordance with FIG. 4.

FIG. 4 illustrates an example embodiment illustrating a network with global detection functionality that is designed to monitor and analyze security threats across an entire network (or network region) instead of on a per-node basis. As the example illustrated in FIG. 4, a networked system 400 may face threats from one or more attackers, such as an attacker A 410 and an attacker B 430. Attacker A may attempt unauthorized access to a first server 420, while attacker B may attempt unauthorized access to both the first server 420 and a second server 440. Without global detection 490, each server may independently record access attempts with mismatched key information. For instance, second server 440 may only log attempts associated with attacker B 430, and if these attempts do not reach the server-specific threshold for a hammer attack, the attack might go undetected. With global detection 490, each server may report access attempts with mismatched information to a centralized server. This centralized server may aggregate data from nodes across the network and conduct a more comprehensive analysis of potential security threats. The centralized server may collect data and perform analysis to identify patterns and correlations that might not be visible at the individual server level. The aggregation and analysis of data network-wide result in a more efficient and accurate detection of attackers. For example, if a third server 460 later receives an access attempt from attacker B 430, third server 460 can immediately recognize the request as high-risk based on the aggregated data and historical analysis. Such detection is made possible because the centralized system has already flagged attacker B as a threat based on previous activities across the network. When third server 460 identifies an attempt from attacker B, third server 460 can block further attempts from this attacker without the need to analyze and receive further faulty attempts from the attacker.

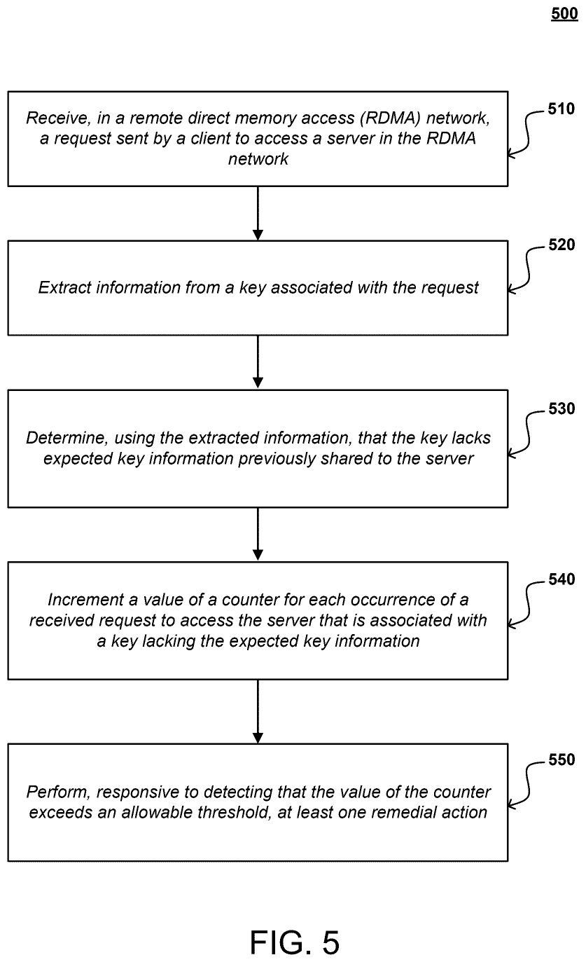

FIG. 5 illustrates an example process 500 that can be performed, such as by using a threat detection system, in accordance with at least one embodiment. It should be understood that for this and other processes discussed and suggested herein there can be additional, fewer, or alternative steps performed in similar or alternative, or at least partially in parallel, within the scope of the various embodiments unless otherwise specifically stated. In this example process 500, a request may be received 510 to a remote direct memory access (RDMA) network, which was sent by a client to attempt to access a server in the RDMA network. From the request, information associated with a key may be extracted 520. In one embodiment, other fields of information, such as Queue Pair Number, Packet Sequence Number, or virtual address may be extracted from the header. The extracted information can be used to determine 530 that the key lacks expected key information previously shared to the server. For example, the key presented in the request may not match the key that was communicated with the server in a connection initiation process. Upon determining that the key information does not match, a value of a counter may be incremented 540 for each occurrence of a received request to access the server that is associated with a key lacking the expected key information. In one embodiment, the counter may keep track of senders that are associated with requests with mismatched information and identify potential attackers. Responsive to detecting that the value of the counter exceeds an allowable threshold, at least one remedial action may be performed 550, such as blocking further requests from one or more specified attackers, freezing the server for a period of time, or sending notification to the server alerting of potential future attacks.

### Data Center

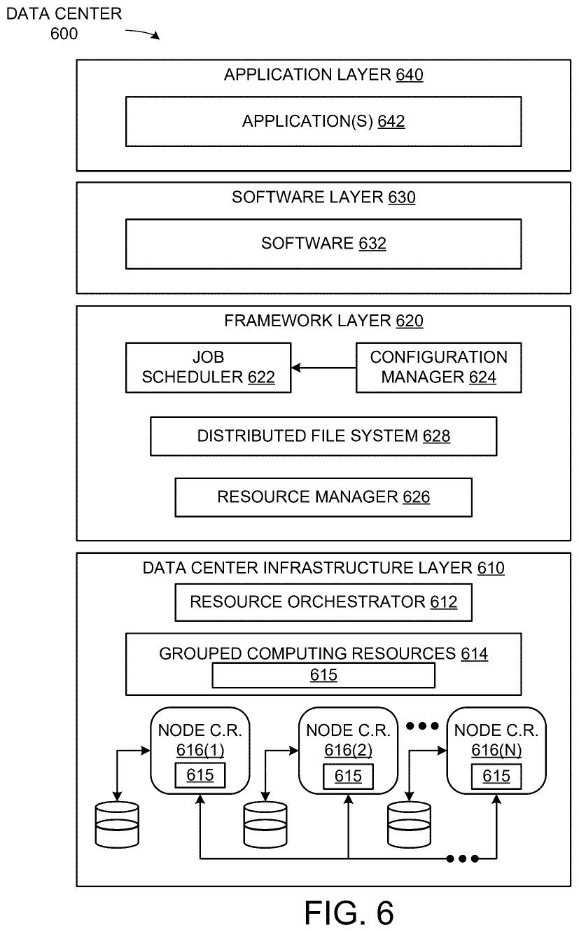

FIG. 6 illustrates an example data center 600, in which at least one embodiment may be used. In at least one embodiment, data center 600 includes a data center infrastructure layer 610, a framework layer 620, a software layer 630 and an application layer 640.

In at least one embodiment, as shown in FIG. 6, data center infrastructure layer 610 may include a resource orchestrator 612, grouped computing resources 614, and node computing resources (“node C.R.s”) 616(1)-616(N), where “N” represents a positive integer (which may be a different integer “N” than used in other figures). In at least one embodiment, node C.R.s 616(1)-616(N) may include, but are not limited to, any number of central processing units (“CPUs”) or other processors (including accelerators, field programmable gate arrays (FPGAs), graphics processors, etc.), memory storage devices 618(1)-618(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of above-mentioned computing resources.

In at least one embodiment, grouped computing resources 614 may include separate groupings of node C.R.s housed within one or more racks (not shown), or many racks housed in data centers at various geographical locations (also not shown). In at least one embodiment, separate groupings of node C.R.s within grouped computing resources 614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for data center 600. In at least one embodiment, resource orchestrator 612 may include hardware, software or some combination thereof.

In at least one embodiment, as shown in FIG. 6, framework layer 620 includes a job scheduler 622, a configuration manager 624, a resource manager 626 and a distributed file system 628. In at least one embodiment, framework layer 620 may include a framework to support software 632 of software layer 630 and/or one or more application(s) 642 of application layer 640. In at least one embodiment, software 632 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may utilize distributed file system 628 for large-scale data processing (e.g., “big data”). In at least one embodiment, job scheduler 622 may include a Spark driver to facilitate scheduling of workloads supported by various layers of data center 600. In at least one embodiment, configuration manager 624 may be capable of configuring different layers such as software layer 630 and framework layer 620 including Spark and distributed file system 628 for supporting large-scale data processing. In at least one embodiment, resource manager 626 may be capable of managing clustered or grouped computing resources mapped to or allocated for support of distributed file system 628 and job scheduler 622. In at least one embodiment, clustered or grouped computing resources may include grouped computing resources 614 at data center infrastructure layer 610. In at least one embodiment, resource manager 626 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 628 of framework layer 620. In at least one embodiment, one or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 628 of framework layer 620. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 624, resource manager 626, and resource orchestrator 612 may implement any number and type of self-modifying actions based on any amount and type of data acquired in any technically feasible fashion. In at least one embodiment, self-modifying actions may relieve a data center operator of data center 600 from making possibly bad configuration decisions and possibly avoiding underutilized and/or poor performing portions of a data center.

In at least one embodiment, data center 600 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 600. In at least one embodiment, trained machine learning models corresponding to one or more neural networks may be used to infer or predict information using resources described above with respect to data center 600 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 6 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

### Computer Systems

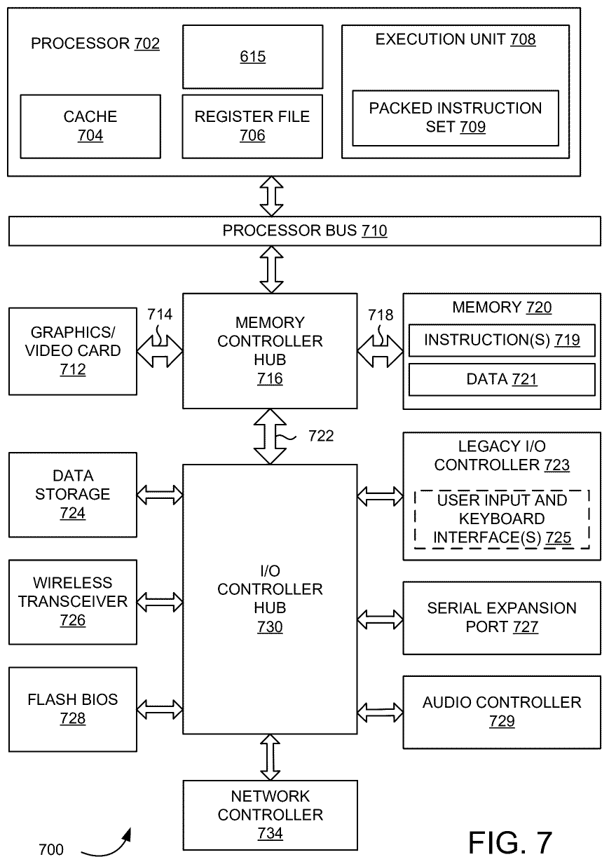

FIG. 7 is a block diagram illustrating an exemplary computer system 700, which may be a system with interconnected devices and components, a system-on-a-chip (SOC) or some combination thereof formed with a processor that may include execution units to execute an instruction, according to at least one embodiment. In at least one embodiment, a computer system 700 may include, without limitation, a component, such as a processor 702 to employ execution units including logic to perform algorithms for process data, in accordance with present disclosure, such as in embodiment described herein. In at least one embodiment, computer system 700 may include processors, such as PENTIUM® Processor family, Xeon™ Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 700 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 700 may include, without limitation, processor 702 that may include, without limitation, one or more execution units 708 to perform machine learning model training and/or inferencing according to techniques described herein. In at least one embodiment, computer system 700 is a single processor desktop or server system, but in another embodiment, computer system 700 may be a multiprocessor system. In at least one embodiment, processor 702 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 702 may be coupled to a processor bus 710 that may transmit data signals between processor 702 and other components in computer system 700.

In at least one embodiment, processor 702 may include, without limitation, a Level 1 (“L1”) internal cache memory (“cache”) 704. In at least one embodiment, processor 702 may have a single internal cache or multiple levels of internal cache. In at least one embodiment, cache memory may reside external to processor 702. Other embodiments may also include a combination of both internal and external caches depending on particular implementation and needs. In at least one embodiment, a register file 706 may store different types of data in various registers including, without limitation, integer registers, floating point registers, status registers, and an instruction pointer register.

In at least one embodiment, execution unit 708, including, without limitation, logic to perform integer and floating point operations, also resides in processor 702. In at least one embodiment, processor 702 may also include a microcode (“ucode”) read only memory (“ROM”) that stores microcode for certain macro instructions. In at least one embodiment, execution unit 708 may include logic to handle a packed instruction set 709. In at least one embodiment, by including packed instruction set 709 in an instruction set of a general-purpose processor, along with associated circuitry to execute instructions, operations used by many multimedia applications may be performed using packed data in processor 702. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 708 may also be used in microcontrollers, embedded processors, graphics devices, DSPs, and other types of logic circuits. In at least one embodiment, computer system 700 may include, without limitation, a memory 720. In at least one embodiment, memory 720 may be a Dynamic Random Access Memory (“DRAM”) device, a Static Random Access Memory (“SRAM”) device, a flash memory device, or another memory device. In at least one embodiment, memory 720 may store instruction(s) 719 and/or data 721 represented by data signals that may be executed by processor 702.

In at least one embodiment, a system logic chip may be coupled to processor bus 710 and memory 720. In at least one embodiment, a system logic chip may include, without limitation, a memory controller hub (“MCH”) 716, and processor 702 may communicate with MCH 716 via processor bus 710. In at least one embodiment, MCH 716 may provide a high bandwidth memory path 718 to memory 720 for instruction and data storage and for storage of graphics commands, data, and textures. In at least one embodiment, MCH 716 may direct data signals between processor 702, memory 720, and other components in computer system 700 and to bridge data signals between processor bus 710, memory 720, and a system I/O interface 722. In at least one embodiment, a system logic chip may provide a graphics port for coupling to a graphics controller. In at least one embodiment, MCH 716 may be coupled to memory 720 through high bandwidth memory path 718 and a graphics/video card 712 may be coupled to MCH 716 through an Accelerated Graphics Port (“AGP”) interconnect 714.

In at least one embodiment, computer system 700 may use system I/O interface 722 as a proprietary hub interface bus to couple MCH 716 to an I/O controller hub (“ICH”) 730. In at least one embodiment, ICH 730 may provide direct connections to some I/O devices via a local I/O bus. In at least one embodiment, a local I/O bus may include, without limitation, a high-speed I/O bus for connecting peripherals to memory 720, a chipset, and processor 702. Examples may include, without limitation, an audio controller 729, a firmware hub (“flash BIOS”) 728, a wireless transceiver 726, a data storage 724, a legacy I/O controller 723 containing user input and keyboard interface(s) 725, a serial expansion port 727, such as a Universal Serial Bus (“USB”) port, and a network controller 734. In at least one embodiment, data storage 724 may comprise a hard disk drive, a floppy disk drive, a CD-ROM device, a flash memory device, or other mass storage device.

In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of computer system 700 are interconnected using compute express link (CXL) interconnects.

Inference and/or training logic 615 are used to perform inferencing and/or training operations associated with one or more embodiments. In at least one embodiment, inference and/or training logic 615 may be used in system FIG. 7 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

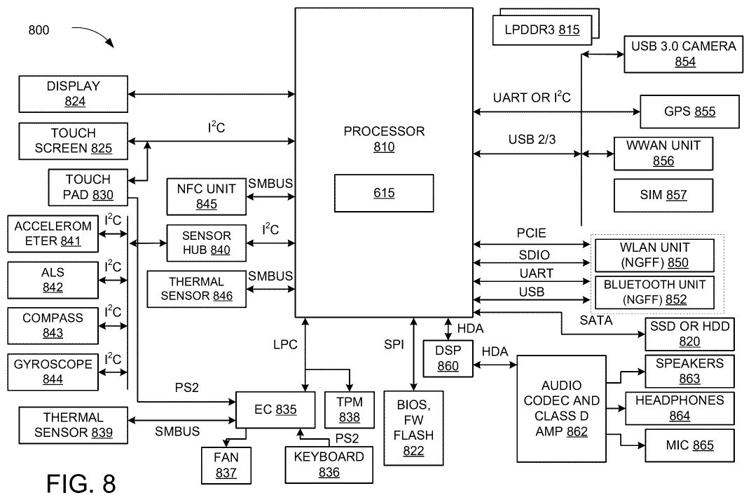

FIG. 8 is a block diagram illustrating an electronic device 800 for utilizing a processor 810, according to at least one embodiment. In at least one embodiment, electronic device 800 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 800 may include, without limitation, processor 810 communicatively coupled to any suitable number or kind of components, peripherals, modules, or devices. In at least one embodiment, processor 810 is coupled using a bus or interface, such as a I²C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 8 illustrates a system, which includes interconnected hardware devices or “chips”, whereas in other embodiments, FIG. 8 may illustrate an exemplary SoC. In at least one embodiment, devices illustrated in FIG. 8 may be interconnected with proprietary interconnects, standardized interconnects (e.g., PCIe) or some combination thereof. In at least one embodiment, one or more components of FIG. 8 are interconnected using compute express link (CXL) interconnects.

In at least one embodiment, FIG. 8 may include a display 824, a touch screen 825, a touch pad 830, a Near Field Communications unit (“NFC”) 845, a sensor hub 840, a thermal sensor 846, an Express Chipset (“EC”) 835, a Trusted Platform Module (“TPM”) 838, BIOS/firmware/flash memory (“BIOS, FW Flash”) 822, a DSP 860, a drive 820 such as a Solid State Disk (“SSD”) or a Hard Disk Drive (“HDD”), a wireless local area network unit (“WLAN”) 850, a Bluetooth unit 852, a Wireless Wide Area Network unit (“WWAN”) 856, a Global Positioning System (GPS) unit 855, a camera (“USB 3.0 camera”) 854 such as a USB 3.0 camera, and/or a Low Power Double Data Rate (“LPDDR”) memory unit (“LPDDR3”) 815 implemented in, for example, an LPDDR3 standard. These components may each be implemented in any suitable manner.

In at least one embodiment, other components may be communicatively coupled to processor 810 through components described herein. In at least one embodiment, an accelerometer 841, an ambient light sensor (“ALS”) 842, a compass 843, and a gyroscope 844 may be communicatively coupled to sensor hub 840. In at least one embodiment, a thermal sensor 839, a fan 837, a keyboard 836, and touch pad 830 may be communicatively coupled to EC 835. In at least one embodiment, speakers 863, headphones 864, and a microphone (“mic”) 865 may be communicatively coupled to an audio unit (“audio codec and class D amp”) 862, which may in turn be communicatively coupled to DSP 860. In at least one embodiment, audio unit 862 may include, for example and without limitation, an audio coder/decoder (“codec”) and a class D amplifier. In at least one embodiment, a SIM card (“SIM”) 857 may be communicatively coupled to WWAN unit 856. In at least one embodiment, components such as WLAN unit 850 and Bluetooth unit 852, as well as WWAN unit 856 may be implemented in a Next Generation Form Factor (“NGFF”).

Inference and/or training logic 615 are used to perform inferencing and/or training operations associated with one or more embodiments. In at least one embodiment, inference and/or training logic 615 may be used in system FIG. 8 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

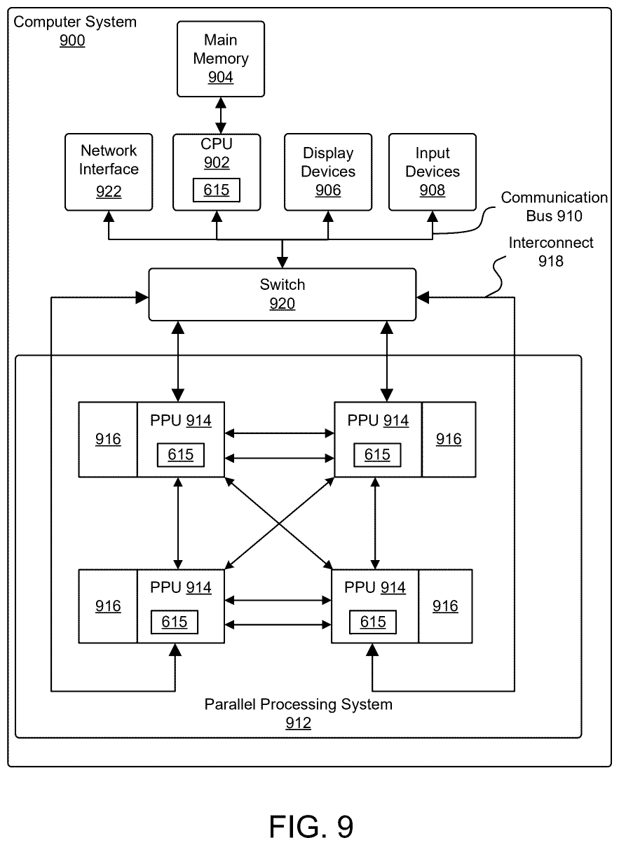

FIG. 9 illustrates a computer system 900, according to at least one embodiment. In at least one embodiment, computer system 900 is configured to implement various processes and methods described throughout this disclosure.

In at least one embodiment, computer system 900 comprises, without limitation, at least one central processing unit (“CPU”) 902 that is connected to a communication bus 910 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 900 includes, without limitation, a main memory 904 and control logic (e.g., implemented as hardware, software, or a combination thereof) and data are stored in main memory 904, which may take form of random access memory (“RAM”). In at least one embodiment, a network interface subsystem (“network interface”) 922 provides an interface to other computing devices and networks for receiving data from and transmitting data to other systems with computer system 900.

In at least one embodiment, computer system 900, in at least one embodiment, includes, without limitation, input devices 908, a parallel processing system 912, and display devices 906 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 908 such as keyboard, mouse, touchpad, microphone, etc. In at least one embodiment, each module described herein can be situated on a single semiconductor platform to form a processing system.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

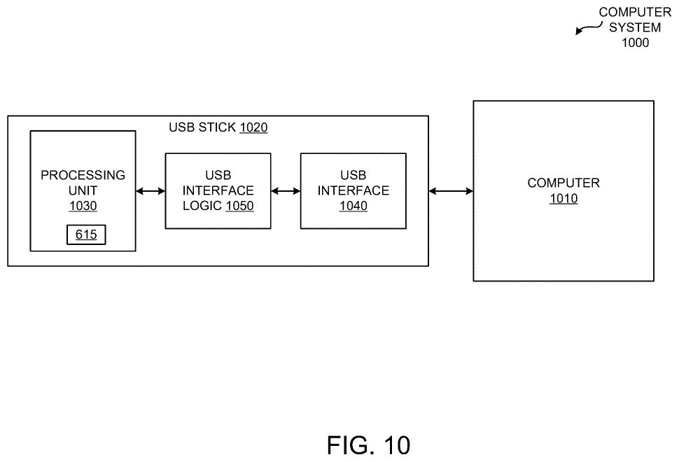

FIG. 10 illustrates a computer system 1000, according to at least one embodiment. In at least one embodiment, computer system 1000 includes, without limitation, a computer 1010 and a USB stick 1020. In at least one embodiment, computer 1010 may include, without limitation, any number and type of processor(s) (not shown) and a memory (not shown). In at least one embodiment, computer 1010 includes, without limitation, a server, a cloud instance, a laptop, and a desktop computer.

In at least one embodiment, USB stick 1020 includes, without limitation, a processing unit 1030, a USB interface 1040, and USB interface logic 1050. In at least one embodiment, processing unit 1030 may be any instruction execution system, apparatus, or device capable of executing instructions. In at least one embodiment, processing unit 1030 may include, without limitation, any number and type of processing cores (not shown). In at least one embodiment, processing unit 1030 comprises an application specific integrated circuit (“ASIC”) that is optimized to perform any amount and type of operations associated with machine learning. For instance, in at least one embodiment, processing unit 1030 is a tensor processing unit (“TPC”) that is optimized to perform machine learning inference operations. In at least one embodiment, processing unit 1030 is a vision processing unit (“VPU”) that is optimized to perform machine vision and machine learning inference operations.

In at least one embodiment, USB interface 1040 may be any type of USB connector or USB socket. For instance, in at least one embodiment, USB interface 1040 is a USB 3.0 Type-C socket for data and power. In at least one embodiment, USB interface 1040 is a USB 3.0 Type-A connector. In at least one embodiment, USB interface logic 1050 may include any amount and type of logic that enables processing unit 1030 to interface with devices (e.g., computer 1010) via USB connector 1040.

Inference and/or training logic 615 are used to perform inferencing and/or training operations associated with one or more embodiments. In at least one embodiment, inference and/or training logic 615 may be used in system FIG. 10 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

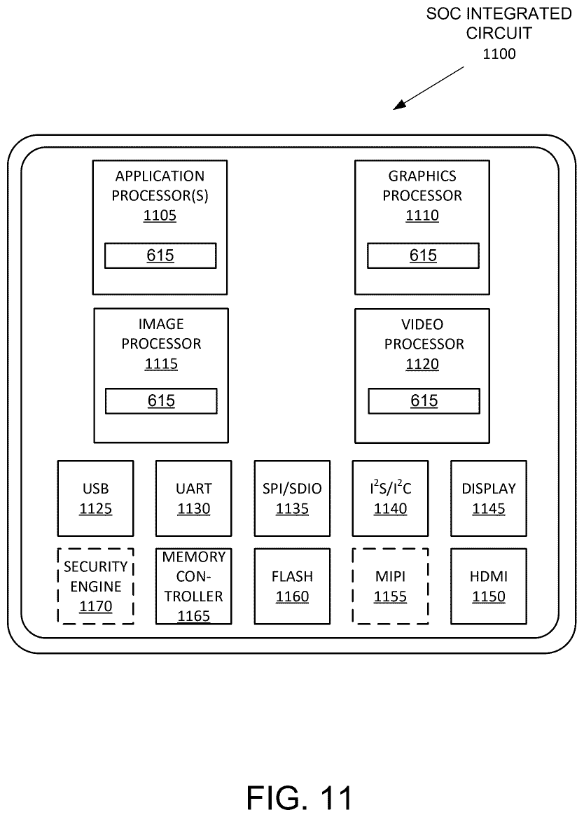

FIG. 11 illustrates exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIG. 11 is a block diagram illustrating an exemplary system on a chip integrated circuit 1100 that may be fabricated using one or more IP cores, according to at least one embodiment. In at least one embodiment, integrated circuit 1100 includes one or more application processor(s) 1105 (e.g., CPUs), at least one graphics processor 1110, and may additionally include an image processor 1115 and/or a video processor 1120, any of which may be a modular IP core. In at least one embodiment, integrated circuit 1100 includes peripheral or bus logic including a USB controller 1125, a UART controller 1130, an SPI/SDIO controller 1135, and an I²2S/I²2C controller 1140. In at least one embodiment, integrated circuit 1100 can include a display device 1145 coupled to one or more of a high-definition multimedia interface (HDMI) controller 1150 and a mobile industry processor interface (MIPI) display interface 1155. In at least one embodiment, storage may be provided by a flash memory subsystem 1160 including flash memory and a flash memory controller. In at least one embodiment, a memory interface may be provided via a memory controller 1165 for access to SDRAM or SRAM memory devices. In at least one embodiment, some integrated circuits additionally include an embedded security engine 1170.

Inference and/or training logic 615 are used to perform inferencing and/or training operations associated with one or more embodiments. In at least one embodiment, inference and/or training logic 615 may be used in integrated circuit 1100 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

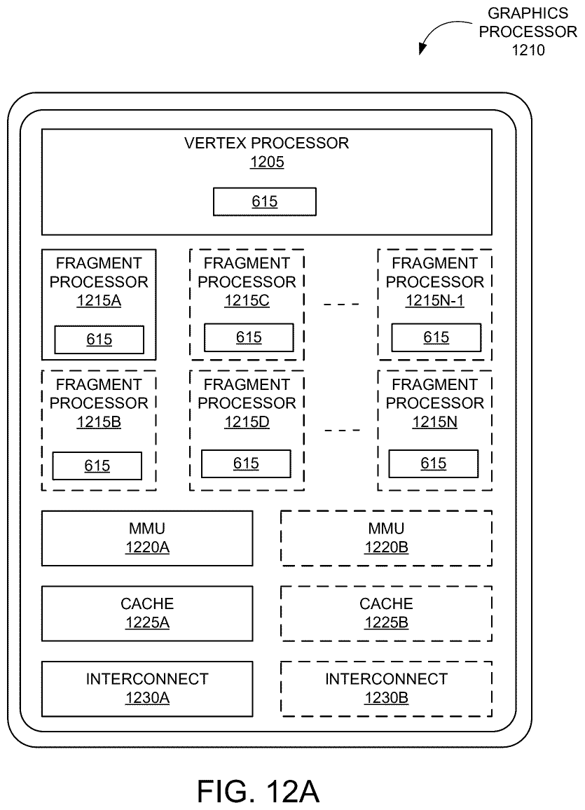

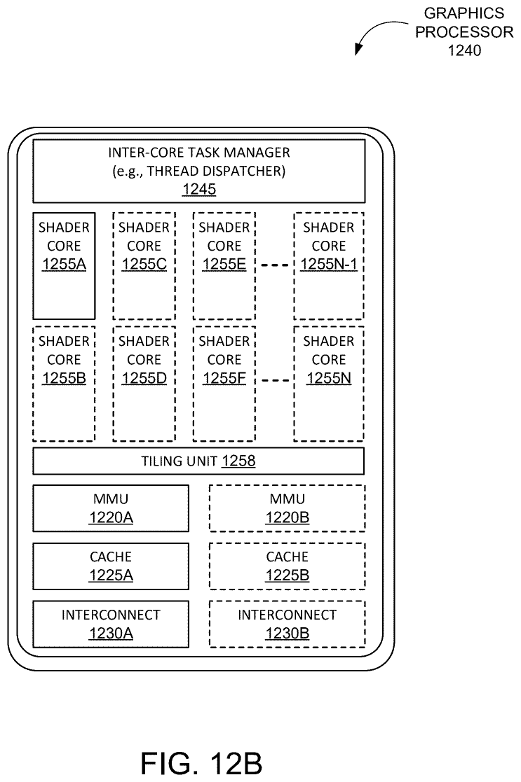

FIGS. 12A-12B illustrate exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIGS. 12A-12B are block diagrams illustrating exemplary graphics processors for use within an SoC, according to embodiments described herein. FIG. 12A illustrates an exemplary graphics processor 1210 of a system on a chip integrated circuit that may be fabricated using one or more IP cores, according to at least one embodiment. FIG. 12B illustrates an additional exemplary graphics processor 1240 of a system on a chip integrated circuit that may be fabricated using one or more IP cores, according to at least one embodiment. In at least one embodiment, graphics processor 1210 of FIG. 12A is a low power graphics processor core. In at least one embodiment, graphics processor 1240 of FIG. 12B is a higher performance graphics processor core. In at least one embodiment, each of graphics processors 1210, 1240 can be variants of computer system 1010 of FIG. 10.

In at least one embodiment, graphics processor 1210 includes a vertex processor 1205 and one or more fragment processor(s) 1215A-1215N (e.g., 1215A, 1215B, 1215C, 1215D, through 1215N-1, and 1215N). In at least one embodiment, graphics processor 1210 can execute different shader programs via separate logic, such that vertex processor 1205 is optimized to execute operations for vertex shader programs, while one or more fragment processor(s) 1215A-1215N execute fragment (e.g., pixel) shading operations for fragment or pixel shader programs. In at least one embodiment, vertex processor 1205 performs a vertex processing stage of a 3D graphics pipeline and generates primitives and vertex data. In at least one embodiment, fragment processor(s) 1215A-1215N use primitive and vertex data generated by vertex processor 1205 to produce a framebuffer that is displayed on a display device. In at least one embodiment, fragment processor(s) 1215A-1215N are optimized to execute fragment shader programs as provided for in an OpenGL API, which may be used to perform similar operations as a pixel shader program as provided for in a Direct 3D API.

In at least one embodiment, graphics processor 1210 additionally includes one or more memory management units (MMUs) 1220A-1220B, cache(s) 1225A-1225B, and circuit interconnect(s) 1230A-1230B. In at least one embodiment, one or more MMU(s) 1220A-1220B provide for virtual to physical address mapping for graphics processor 1210, including for vertex processor 1205 and/or fragment processor(s) 1215A-1215N, which may reference vertex or image/texture data stored in memory, in addition to vertex or image/texture data stored in one or more cache(s) 1225A-1225B. In at least one embodiment, one or more MMU(s) 1220A-1220B may be synchronized with other MMUs within a system, including one or more MMUs associated with one or more application processor(s) 1205, image processors 1215, and/or video processors 1220 of FIG. 12A, such that each processor 1205-1220 can participate in a shared or unified virtual memory system. In at least one embodiment, one or more circuit interconnect(s) 1230A-1230B enable graphics processor 1210 to interface with other IP cores within SoC, either via an internal bus of SoC or via a direct connection.

In at least one embodiment, graphics processor 1240 includes one or more shader core(s) 1255A-1255N (e.g., 1255A, 1255B, 1255C, 1255D, 1255E, 1255F, through 1255N-1, and 1255N) as shown in FIG. 12B, which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 1240 includes an inter-core task manager 1245, which acts as a thread dispatcher to dispatch execution threads to one or more shader cores 1255A-1255N and a tiling unit 1258 to accelerate tiling operations for tile-based rendering, in which rendering operations for a scene are subdivided in image space, for example to exploit local spatial coherence within a scene or to optimize use of internal caches.

Embodiments presented herein can allow for a linear regulator with one or more features for improving the PSRR to identify and correct voltage noise within a circuit.

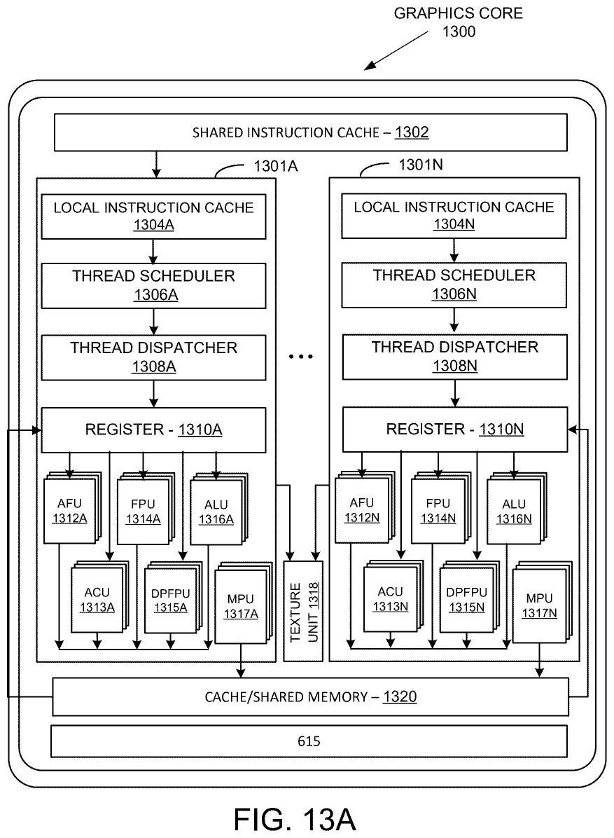

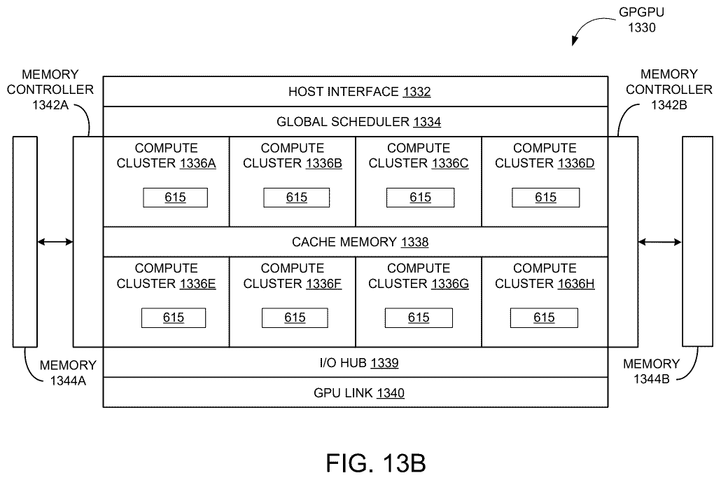

FIGS. 13A-13B illustrate additional exemplary graphics processor logic according to embodiments described herein. FIG. 13A illustrates a graphics core 1300 that may be included within graphics processor 1110 of FIG. 11, in at least one embodiment, and may be a unified shader core 1155A-1155N as in FIG. 11 in at least one embodiment. FIG. 13B illustrates a highly-parallel general-purpose graphics processing unit (“GPGPU”) 1330 suitable for deployment on a multi-chip module in at least one embodiment.

In at least one embodiment, graphics core 1300 includes a shared instruction cache 1302, a texture unit 1318, and a cache/shared memory 1320 (e.g., including L1, L2, L3, last level cache, or other caches) that are common to execution resources within graphics core 1300. In at least one embodiment, graphics core 1300 can include multiple slices 1301A-1301N or a partition for each core, and a graphics processor can include multiple instances of graphics core 1300. In at least one embodiment, each slice 1301A-1301N refers to graphics core 1300. In at least one embodiment, slices 1301A-1301N have sub-slices, which are part of a slice 1301A-1301N. In at least one embodiment, slices 1301A-1301N are independent of other slices or dependent on other slices. In at least one embodiment, slices 1301A-1301N can include support logic including a local instruction cache 1304A-1304N, a thread scheduler (sequencer) 1306A-1306N, a thread dispatcher 1308A-1308N, and a set of registers 1310A-1310N. In at least one embodiment, slices 1301A-1301N can include a set of additional function units (AFUs 1312A-1312N), floating-point units (FPUs 1314A-1314N), integer arithmetic logic units (ALUs 1316A-1316N), address computational units (ACUs 1313A-1313N), double-precision floating-point units (DPFPUs 1315A-1315N), and matrix processing units (MPUs 1317A-1317N).

In at least one embodiment, each slice 1301A-1301N includes one or more engines for floating point and integer vector operations and one or more engines to accelerate convolution and matrix operations in AI, machine learning, or large dataset workloads. In at least one embodiment, one or more slices 1301A-1301N include one or more vector engines to compute a vector (e.g., compute mathematical operations for vectors). In at least one embodiment, a vector engine can compute a vector operation in 15-bit floating point (also referred to as “FP16”), 32-bit floating point (also referred to as “FP32”), or 64-bit floating point (also referred to as “FP64”). In at least one embodiment, one or more slices 1301A-1301N includes 15 vector engines that are paired with 15 matrix math units to compute matrix/tensor operations, where vector engines and math units are exposed via matrix extensions. In at least one embodiment, a slice is a specified portion of processing resources of a processing unit, e.g., 15 cores and a ray tracing unit or 8 cores, a thread scheduler, a thread dispatcher, and additional functional units for a processor. In at least one embodiment, graphics core 1300 includes one or more matrix engines to compute matrix operations, e.g., when computing tensor operations.

In at least one embodiment, one or more slices 1301A-1301N includes one or more ray tracing units to compute ray tracing operations (e.g., 15 ray tracing units per slice slices 1301A-1301N). In at least one embodiment, a ray tracing unit computes ray traversal, triangle intersection, bounding box intersect, or other ray tracing operations.

In at least one embodiment, one or more slices 1301A-1301N includes a media slice that encodes, decodes, and/or transcodes data; scales and/or format converts data; and/or performs video quality operations on video data.

In at least one embodiment, one or more slices 1301A-1301N are linked to L2 cache and memory fabric, link connectors, high-bandwidth memory (HBM) (e.g., HBM2e, HDM3) stacks, and a media engine. In at least one embodiment, one or more slices 1301A-1301N include multiple cores (e.g., 15 cores) and multiple ray tracing units (e.g., 15) paired to each core. In at least one embodiment, one or more slices 1301A-1301N have one or more L1 caches. In at least one embodiment, one or more slices 1301A-1301N include one or more vector engines; one or more instruction caches to store instructions; one or more L1 caches to cache data; one or more shared local memories (SLMs) to store data, e.g., corresponding to instructions; one or more samplers to sample data; one or more ray tracing units to perform ray tracing operations; one or more geometries to perform operations in geometry pipelines and/or apply geometric transformations to vertices or polygons; one or more rasterizers to describe an image in vector graphics format (e.g., shape) and convert it into a raster image (e.g., a series of pixels, dots, or lines, which when displayed together, create an image that is represented by shapes); one or more a Hierarchical Depth Buffer (Hiz) to buffer data; and/or one or more pixel backends. In at least one embodiment, a slice 1301A-1301N includes a memory fabric, e.g., an L2 cache.

In at least one embodiment, FPUs 1314A-1314N can perform single-precision (32-bit) and half-precision (16-bit) floating point operations, while DPFPUs 1315A-1315N perform double precision (64-bit) floating point operations. In at least one embodiment, ALUs 1316A-1316N can perform variable precision integer operations at 8-bit, 15-bit, and 32-bit precision, and can be configured for mixed precision operations. In at least one embodiment, MPUs 1317A-1317N can also be configured for mixed precision matrix operations, including half-precision floating point and 8-bit integer operations. In at least one embodiment, MPUs 1317-1317N can perform a variety of matrix operations to accelerate machine learning application frameworks, including enabling support for accelerated general matrix to matrix multiplication (GEMM). In at least one embodiment, AFUs 1312A-1312N can perform additional logic operations not supported by floating-point or integer units, including trigonometric operations (e.g., sine, cosiInference and/or training logic 615 are used to perform inferencing and/or training operations associated with one or more embodiments. In at least one embodiment, inference and/or training logic 615 may be used in graphics core 1300 for inferencing or predicting operations based, at least in part, on weight parameters calculated using neural network training operations, neural network functions and/or architectures, or neural network use cases described herein.

In at least one embodiment, graphics core 1300 includes an interconnect and a link fabric sublayer that is attached to a switch and a GPU-GPU bridge that enables multiple graphics processors 1300 (e.g., 8) to be interlinked without glue to each other with load/store units (LSUs), data transfer units, and sync semantics across multiple graphics processors 1300. In at least one embodiment, interconnects include standardized interconnects (e.g., PCIe) or some combination thereof.

In at least one embodiment, graphics core 1300 includes multiple tiles. In at least one embodiment, a tile is an individual die or one or more dies, where individual dies can be connected with an interconnect (e.g., embedded multi-die interconnect bridge (EMIB)). In at least one embodiment, graphics core 1300 includes a compute tile, a memory tile (e.g., where a memory tile can be exclusively accessed by different tiles or different chipsets such as a Rambo tile), substrate tile, a base tile, a HMB tile, a link tile, and EMIB tile, where all tiles are packaged together in graphics core 1300 as part of a GPU. In at least one embodiment, graphics core 1300 can include multiple tiles in a single package (also referred to as a “multi tile package”). In at least one embodiment, a compute tile can have 8 graphics cores 1300, an L1 cache; and a base tile can have a host interface with PCIe 5.0, HBM2e, MDFI, and EMIB, a link tile with 8 links, 8 ports with an embedded switch. In at least one embodiment, tiles are connected with face-to-face (F2F) chip-on-chip bonding through fine-pitched, 36-micron, microbumps (e.g., copper pillars). In at least one embodiment, graphics core 1300 includes memory fabric, which includes memory, and is tile that is accessible by multiple tiles. In at least one embodiment, graphics core 1300 stores, accesses, or loads its own hardware contexts in memory, where a hardware context is a set of data loaded from registers before a process resumes, and where a hardware context can indicate a state of hardware (e.g., state of a GPU).

In at least one embodiment, graphics core 1300 includes serializer/deserializer (SERDES) circuitry that converts a serial data stream to a parallel data stream, or converts a parallel data stream to a serial data stream.

In at least one embodiment, graphics core 1300 includes a high speed coherent unified fabric (GPU to GPU), load/store units, bulk data transfer and sync semantics, and connected GPUs through an embedded switch, where a GPU-GPU bridge is controlled by a controller.

In at least one embodiment, graphics core 1300 performs an API, where said API abstracts hardware of graphics core 1300 and access libraries with instructions to perform math operations (e.g., math kernel library), deep neural network operations (e.g., deep neural network library), vector operations, collective communications, thread building blocks, video processing, data analytics library, and/or ray tracing operations.

Embodiments presented herein can allow for a linear regulator with one or more features for improving the PSRR to identify and correct voltage noise within a circuit.

FIG. 13B illustrates a general-purpose processing unit (GPGPU) 1330 that can be configured to enable highly-parallel compute operations to be performed by an array of graphics processing units, in at least one embodiment. In at least one embodiment, GPGPU 1330 can be linked directly to other instances of GPGPU 1330 to create a multi-GPU cluster to improve training speed for deep neural networks. In at least one embodiment, GPGPU 1330 includes a host interface 1332 to enable a connection with a host processor. In at least one embodiment, host interface 1332 is a PCI Express interface. In at least one embodiment, host interface 1332 can be a vendor-specific communications interface or communications fabric. In at least one embodiment, GPGPU 1330 receives commands from a host processor and uses a global scheduler 1334 (which may be referred to as a thread sequencer and/or asynchronous compute engine) to distribute execution threads associated with those commands to a set of compute clusters 1336A-1336H. In at least one embodiment, compute clusters 1336A-1336H share a cache memory 1338. In at least one embodiment, cache memory 1338 can serve as a higher-level cache for cache memories within compute clusters 1336A-1336H.

In at least one embodiment, GPGPU 1330 includes memory 1344A-1344B coupled with compute clusters 1336A-1336H via a set of memory controllers 1342A-1342B (e.g., one or more controllers for HBM2e). In at least one embodiment, memory 1344A-1344B can include various types of memory devices including dynamic random access memory (DRAM) or graphics random access memory, such as synchronous graphics random access memory (SGRAM), including graphics double data rate (GDDR) memory.

In at least one embodiment, compute clusters 1336A-1336H each include a set of graphics cores, such as graphics core 1300 of FIG. 13A, which can include multiple types of integer and floating point logic units that can perform computational operations at a range of precisions including suited for machine learning computations. For example, in at least one embodiment, at least a subset of floating point units in each of compute clusters 1336A-1336H can be configured to perform 15-bit or 32-bit floating point operations, while a different subset of floating point units can be configured to perform 64-bit floating point operations.

In at least one embodiment, multiple instances of GPGPU 1330 can be configured to operate as a compute cluster. In at least one embodiment, communication used by compute clusters 1336A-1336H for synchronization and data exchange varies across embodiments. In at least one embodiment, multiple instances of GPGPU 1330 communicate over host interface 1332. In at least one embodiment, GPGPU 1330 includes an I/O hub 1339 that couples GPGPU 1330 with a GPU link 1340 that enables a direct connection to other instances of GPGPU 1330. In at least one embodiment, GPU link 1340 is coupled to a dedicated GPU-to-GPU bridge that enables communication and synchronization between multiple instances of GPGPU 1330. In at least one embodiment, GPU link 1340 couples with a high-speed interconnect to transmit and receive data to other GPGPUs or parallel processors. In at least one embodiment, multiple instances of GPGPU 1330 are located in separate data processing systems and communicate via a network device that is accessible via host interface 1332. In at least one embodiment GPU link 1340 can be configured to enable a connection to a host processor in addition to or as an alternative to host interface 1332.

In at least one embodiment, GPGPU 1330 can be configured to train neural networks. In at least one embodiment, GPGPU 1330 can be used within an inferencing platform. In at least one embodiment, in which GPGPU 1330 is used for inferencing, GPGPU 1330 may include fewer compute clusters 1336A-1336H relative to when GPGPU 1330 is used for training a neural network. In at least one embodiment, memory technology associated with memory 1344A-1344B may differ between inferencing and training configurations, with higher bandwidth memory technologies devoted to training configurations. In at least one embodiment, an inferencing configuration of GPGPU 1330 can support inferencing specific instructions. For example, in at least one embodiment, an inferencing configuration can provide support for one or more 8-bit integer dot product instructions, which may be used during inferencing operations for deployed neural networks.

Inference and/or training logic 615 are used to perform inferencing and/or training operations associated with one or more embodiments. In at least one embodiment, inference and/or training logic 615 may be used in GPGPU 1330 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

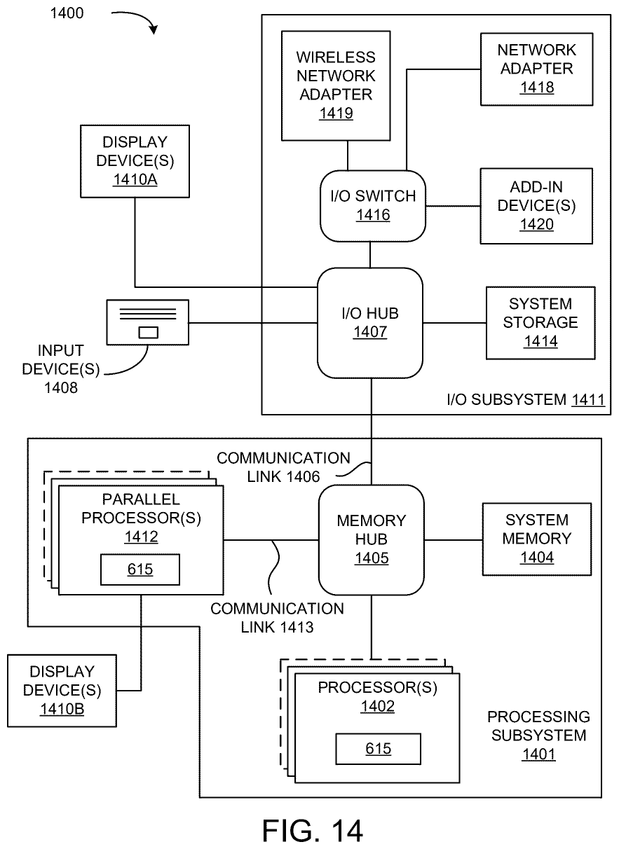

FIG. 14 is a block diagram illustrating a computing system 1400 according to at least one embodiment. In at least one embodiment, computing system 1400 includes a processing subsystem 1401 having one or more processor(s) 1402 and a system memory 1404 communicating via an interconnection path that may include a memory hub 1405. In at least one embodiment, memory hub 1405 may be a separate component within a chipset component or may be integrated within one or more processor(s) 1402. In at least one embodiment, memory hub 1405 couples with an I/O subsystem 1411 via a communication link 1406. In at least one embodiment, I/O subsystem 1411 includes an I/O hub 1407 that can enable computing system 1400 to receive input from one or more input device(s) 1408. In at least one embodiment, I/O hub 1407 can enable a display controller, which may be included in one or more processor(s) 1402, to provide outputs to one or more display device(s) 1410A. In at least one embodiment, one or more display device(s) 1410A coupled with I/O hub 1407 can include a local, internal, or embedded display device.

In at least one embodiment, processing subsystem 1401 includes one or more parallel processor(s) 1412 coupled to memory hub 1405 via a bus or other communication link 1413. In at least one embodiment, communication link 1413 may use one of any number of standards based communication link technologies or protocols, such as but not limited to PCI Express, or may be a vendor-specific communications interface or communications fabric. In at least one embodiment, one or more parallel processor(s) 1412 form a computationally focused parallel or vector processing system that can include a large number of processing cores and/or processing clusters, such as a many-integrated core (MIC) processor. In at least one embodiment, some or all of parallel processor(s) 1412 form a graphics processing subsystem that can output pixels to one of one or more display device(s) 1410A coupled via I/O Hub 1407. In at least one embodiment, parallel processor(s) 1412 can also include a display controller and display interface (not shown) to enable a direct connection to one or more display device(s) 1410B. In at least one embodiment, parallel processor(s) 1412 include one or more cores, such as graphics cores 1300 discussed herein.

In at least one embodiment, a system storage unit 1414 can connect to I/O hub 1407 to provide a storage mechanism for computing system 1400. In at least one embodiment, an I/O switch 1416 can be used to provide an interface mechanism to enable connections between I/O hub 1407 and other components, such as a network adapter 1418 and/or a wireless network adapter 1419 that may be integrated into platform, and various other devices that can be added via one or more add-in device(s) 1420. In at least one embodiment, network adapter 1418 can be an Ethernet adapter or another wired network adapter. In at least one embodiment, wireless network adapter 1419 can include one or more of a Wi-Fi, Bluetooth, near field communication (NFC), or other network device that includes one or more wireless radios.

In at least one embodiment, computing system 1400 can include other components not explicitly shown, including USB or other port connections, optical storage drives, video capture devices, and like, may also be connected to I/O hub 1407. In at least one embodiment, communication paths interconnecting various components in FIG. 14 may be implemented using any suitable protocols, such as PCI (Peripheral Component Interconnect) based protocols (e.g., PCI-Express), or other bus or point-to-point communication interfaces and/or protocol(s), such as NV-Link high-speed interconnect, or interconnect protocols.

In at least one embodiment, parallel processor(s) 1412 incorporate circuitry optimized for graphics and video processing, including, for example, video output circuitry, and constitutes a graphics processing unit (GPU), e.g., parallel processor(s) 1412 includes graphics core 1300. In at least one embodiment, parallel processor(s) 1412 incorporate circuitry optimized for general purpose processing. In at least embodiment, components of computing system 1400 may be integrated with one or more other system elements on a single integrated circuit. For example, in at least one embodiment, parallel processor(s) 1412, memory hub 1405, processor(s) 1402, and I/O hub 1407 can be integrated into a system on chip (SoC) integrated circuit. In at least one embodiment, components of computing system 1400 can be integrated into a single package to form a system in package (SIP) configuration. In at least one embodiment, at least a portion of components of computing system 1400 can be integrated into a multi-chip module (MCM), which can be interconnected with other multi-chip modules into a modular computing system.

Inference and/or training logic 615 are used to perform inferencing and/or training operations associated with one or more embodiments. In at least one embodiment, inference and/or training logic 615 may be used in system FIG. 14 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

### Processors

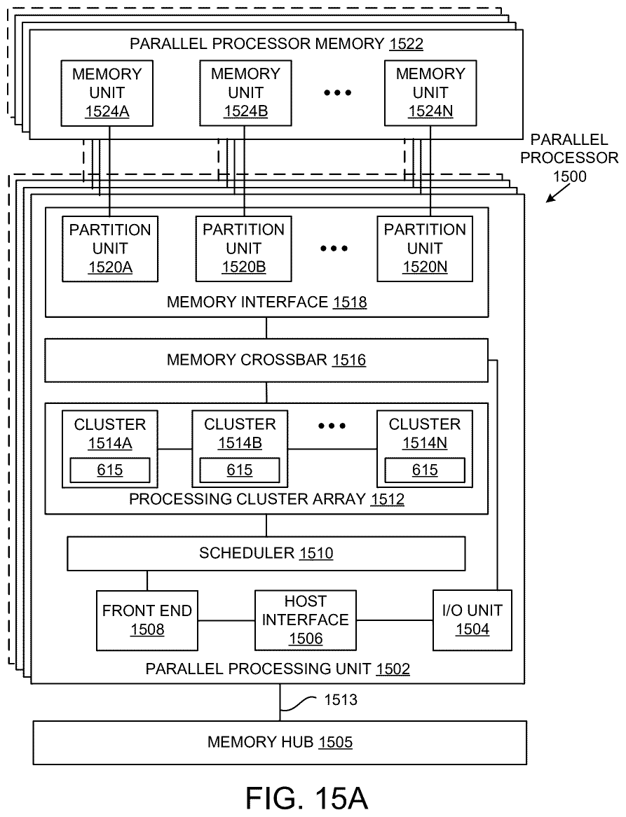

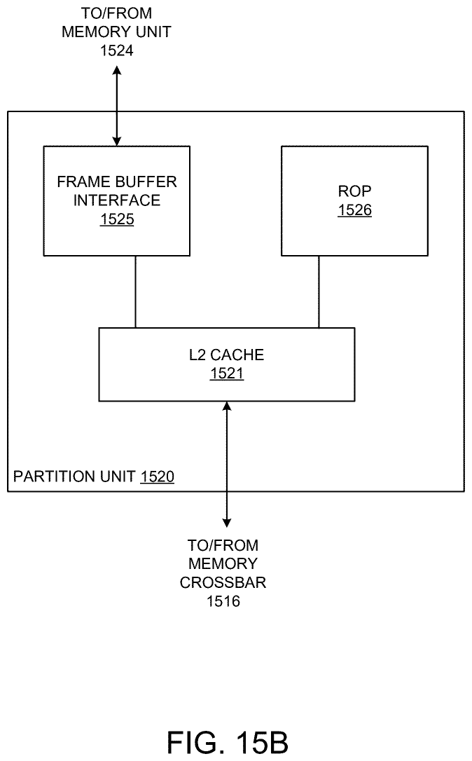

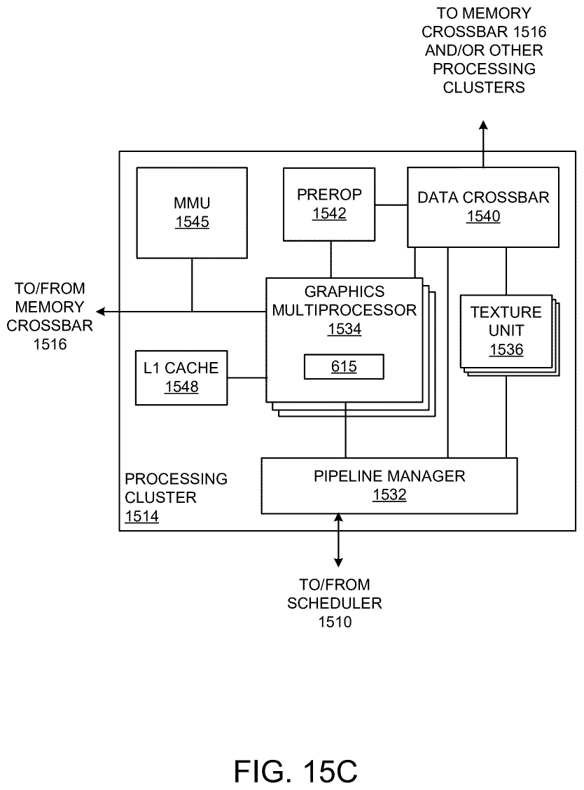

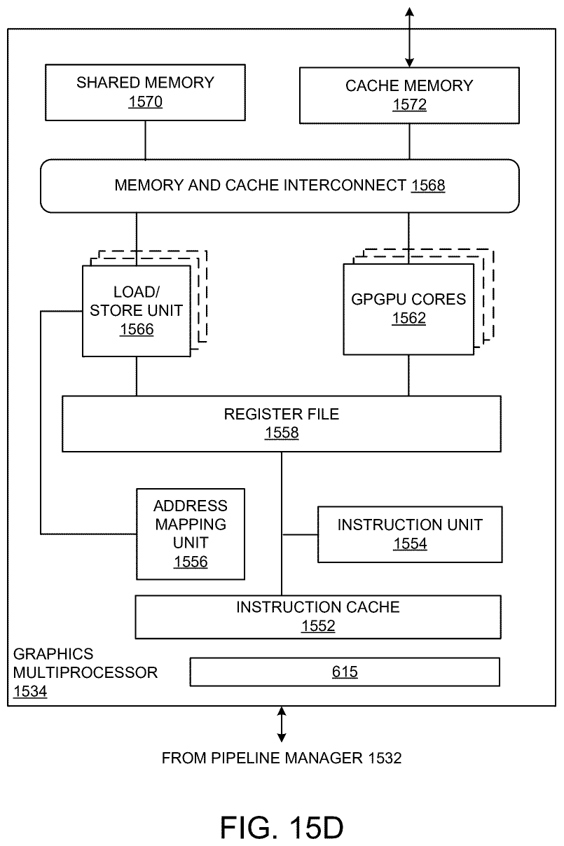

FIG. 15A illustrates a parallel processor 1500 according to at least one embodiment. In at least one embodiment, various components of parallel processor 1500 may be implemented using one or more integrated circuit devices, such as programmable processors, application specific integrated circuits (ASICs), or field programmable gate arrays (FPGA). In at least one embodiment, illustrated parallel processor 1500 is a variant of one or more parallel processor(s) 1412 shown in FIG. 14 according to an exemplary embodiment. In at least one embodiment, a parallel processor 1500 includes one or more graphics cores 1300.

In at least one embodiment, parallel processor 1500 includes a parallel processing unit 1502. In at least one embodiment, parallel processing unit 1502 includes an I/O unit 1504 that enables communication with other devices, including other instances of parallel processing unit 1502. In at least one embodiment, I/O unit 1504 may be directly connected to other devices. In at least one embodiment, I/O unit 1504 connects with other devices via use of a hub or switch interface, such as a memory hub 1505. In at least one embodiment, connections between memory hub 1505 and I/O unit 1504 form a communication link 1513. In at least one embodiment, I/O unit 1504 connects with a host interface 1506 and a memory crossbar 1516, where host interface 1506 receives commands directed to performing processing operations and memory crossbar 1516 receives commands directed to performing memory operations.

In at least one embodiment, when host interface 1506 receives a command buffer via I/O unit 1504, host interface 1506 can direct work operations to perform those commands to a front end 1508. In at least one embodiment, front end 1508 couples with a scheduler 1510 (which may be referred to as a sequencer), which is configured to distribute commands or other work items to a processing cluster array 1512. In at least one embodiment, scheduler 1510 ensures that processing cluster array 1512 is properly configured and in a valid state before tasks are distributed to a cluster of processing cluster array 1512. In at least one embodiment, scheduler 1510 is implemented via firmware logic executing on a microcontroller. In at least one embodiment, microcontroller implemented scheduler 1510 is configurable to perform complex scheduling and work distribution operations at coarse and fine granularity, enabling rapid preemption and context switching of threads executing on processing array 1512. In at least one embodiment, host software can prove workloads for scheduling on processing cluster array 1512 via one of multiple graphics processing paths. In at least one embodiment, workloads can then be automatically distributed across processing array cluster 1512 by scheduler 1510 logic within a microcontroller including scheduler 1510.

In at least one embodiment, processing cluster array 1512 can include up to “N” processing clusters (e.g., cluster 1514A, cluster 1514B, through cluster 1514N), where “N” represents a positive integer (which may be a different integer “N” than used in other figures). In at least one embodiment, each cluster 1514A-1514N of processing cluster array 1512 can execute a large number of concurrent threads. In at least one embodiment, scheduler 1510 can allocate work to clusters 1514A-1514N of processing cluster array 1512 using various scheduling and/or work distribution algorithms, which may vary depending on workload arising for each type of program or computation. In at least one embodiment, scheduling can be handled dynamically by scheduler 1510, or can be assisted in part by compiler logic during compilation of program logic configured for execution by processing cluster array 1512. In at least one embodiment, different clusters 1514A-1514N of processing cluster array 1512 can be allocated for processing different types of programs or for performing different types of computations.

In at least one embodiment, processing cluster array 1512 can be configured to perform various types of parallel processing operations. In at least one embodiment, processing cluster array 1512 is configured to perform general-purpose parallel compute operations. For example, in at least one embodiment, processing cluster array 1512 can include logic to execute processing tasks including filtering of video and/or audio data, performing modeling operations, including physics operations, and performing data transformations.

In at least one embodiment, processing cluster array 1512 is configured to perform parallel graphics processing operations. In at least one embodiment, processing cluster array 1512 can include additional logic to support execution of such graphics processing operations, including but not limited to, texture sampling logic to perform texture operations, as well as tessellation logic and other vertex processing logic. In at least one embodiment, processing cluster array 1512 can be configured to execute graphics processing related shader programs such as but not limited to, vertex shaders, tessellation shaders, geometry shaders, and pixel shaders. In at least one embodiment, parallel processing unit 1502 can transfer data from system memory via I/O unit 1504 for processing. In at least one embodiment, during processing, transferred data can be stored to on-chip memory (e.g., parallel processor memory 1522) during processing, then written back to system memory.

In at least one embodiment, when parallel processing unit 1502 is used to perform graphics processing, scheduler 1510 can be configured to divide a processing workload into approximately equal sized tasks, to better enable distribution of graphics processing operations to multiple clusters 1514A-1514N of processing cluster array 1512. In at least one embodiment, portions of processing cluster array 1512 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1514A-1514N may be stored in buffers to allow intermediate data to be transmitted between clusters 1514A-1514N for further processing.

In at least one embodiment, processing cluster array 1512 can receive processing tasks to be executed via scheduler 1510, which receives commands defining processing tasks from front end 1508. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1510 may be configured to fetch indices corresponding to tasks or may receive indices from front end 1508. In at least one embodiment, front end 1508 can be configured to ensure processing cluster array 1512 is configured to a valid state before a workload specified by incoming command buffers (e.g., batch-buffers, push buffers, etc.) is initiated.

In at least one embodiment, each of one or more instances of parallel processing unit 1502 can couple with a parallel processor memory 1522. In at least one embodiment, parallel processor memory 1522 can be accessed via memory crossbar 1516, which can receive memory requests from processing cluster array 1512 as well as I/O unit 1504. In at least one embodiment, memory crossbar 1516 can access parallel processor memory 1522 via a memory interface 1518. In at least one embodiment, memory interface 1518 can include multiple partition units (e.g., partition unit 1520A, partition unit 1520B, through partition unit 1520N) that can each couple to a portion (e.g., memory unit) of parallel processor memory 1522. In at least one embodiment, a number of partition units 1520A-1520N is configured to be equal to a number of memory units, such that a first partition unit 1520A has a corresponding first memory unit 1524A, a second partition unit 1520B has a corresponding memory unit 1524B, and an N-th partition unit 1520N has a corresponding N-th memory unit 1524N. In at least one embodiment, a number of partition units 1520A-1520N may not be equal to a number of memory units.

In at least one embodiment, memory units 1524A-1524N can include various types of memory devices, including dynamic random access memory (DRAM) or graphics random access memory, such as synchronous graphics random access memory (SGRAM), including graphics double data rate (GDDR) memory. In at least one embodiment, memory units 1524A-1524N may also include 3D stacked memory, including but not limited to high bandwidth memory (HBM), HBM2e, or HDM3. In at least one embodiment, render targets, such as frame buffers or texture maps may be stored across memory units 1524A-1524N, allowing partition units 1520A-1520N to write portions of each render target in parallel to efficiently use available bandwidth of parallel processor memory 1522. In at least one embodiment, a local instance of parallel processor memory 1522 may be excluded in favor of a unified memory design that utilizes system memory in conjunction with local cache memory.

In at least one embodiment, any one of clusters 1514A-1514N of processing cluster array 1512 can process data that will be written to any of memory units 1524A-1524N within parallel processor memory 1522. In at least one embodiment, memory crossbar 1516 can be configured to transfer an output of each cluster 1514A-1514N to any partition unit 1520A-1520N or to another cluster 1514A-1514N, which can perform additional processing operations on an output. In at least one embodiment, each cluster 1514A-1514N can communicate with memory interface 1518 through memory crossbar 1516 to read from or write to various external memory devices. In at least one embodiment, memory crossbar 1516 has a connection to memory interface 1518 to communicate with I/O unit 1504, as well as a connection to a local instance of parallel processor memory 1522, enabling processing units within different processing clusters 1514A-1514N to communicate with system memory or other memory that is not local to parallel processing unit 1502. In at least one embodiment, memory crossbar 1516 can use virtual channels to separate traffic streams between clusters 1514A-1514N and partition units 1520A-1520N.

In at least one embodiment, multiple instances of parallel processing unit 1502 can be provided on a single add-in card, or multiple add-in cards can be interconnected. In at least one embodiment, different instances of parallel processing unit 1502 can be configured to interoperate even if different instances have different numbers of processing cores, different amounts of local parallel processor memory, and/or other configuration differences. For example, in at least one embodiment, some instances of parallel processing unit 1502 can include higher precision floating point units relative to other instances. In at least one embodiment, systems incorporating one or more instances of parallel processing unit 1502 or parallel processor 1500 can be implemented in a variety of configurations and form factors, including but not limited to desktop, laptop, or handheld personal computers, servers, workstations, game consoles, and/or embedded systems.

FIG. 15B is a block diagram of a partition unit 1520 according to at least one embodiment. In at least one embodiment, partition unit 1520 is an instance of one of partition units 1520A-1520N of FIG. 15A. In at least one embodiment, partition unit 1520 includes an L2 cache 1521, a frame buffer interface 1525, and a ROP 1526 (raster operations unit). In at least one embodiment, L2 cache 1521 is a read/write cache that is configured to perform load and store operations received from memory crossbar 1516 and ROP 1526. In at least one embodiment, read misses and urgent write-back requests are output by L2 cache 1521 to frame buffer interface 1525 for processing. In at least one embodiment, updates can also be sent to a frame buffer via frame buffer interface 1525 for processing. In at least one embodiment, frame buffer interface 1525 interfaces with one of memory units in parallel processor memory, such as memory units 1524A-1524N of FIG. 15A (e.g., within parallel processor memory 1522).

In at least one embodiment, ROP 1526 is a processing unit that performs raster operations such as stencil, z test, blending, etc. In at least one embodiment, ROP 1526 then outputs processed graphics data that is stored in graphics memory. In at least one embodiment, ROP 1526 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1526 can vary based on statistical characteristics of data to be compressed. For example, in at least one embodiment, delta color compression is performed on depth and color data on a per-tile basis.

In at least one embodiment, ROP 1526 is included within each processing cluster (e.g., cluster 1514A-1514N of FIG. 15A) instead of within partition unit 1520. In at least one embodiment, read and write requests for pixel data are transmitted over memory crossbar 1516 instead of pixel fragment data. In at least one embodiment, processed graphics data may be displayed on a display device, such as one of one or more display device(s) 1410 of FIG. 14, routed for further processing by processor(s) 1402, or routed for further processing by one of processing entities within parallel processor 1500 of FIG. 15A.

FIG. 15C is a block diagram of a processing cluster 1514 within a parallel processing unit according to at least one embodiment. In at least one embodiment, a processing cluster is an instance of one of processing clusters 1514A-1514N of FIG. 15A. In at least one embodiment, processing cluster 1514 can be configured to execute many threads in parallel, where “thread” refers to an instance of a particular program executing on a particular set of input data. In at least one embodiment, single-instruction, multiple-data (SIMD) instruction issue techniques are used to support parallel execution of a large number of threads without providing multiple independent instruction units. In at least one embodiment, single-instruction, multiple-thread (SIMT) techniques are used to support parallel execution of a large number of generally synchronized threads, using a common instruction unit configured to issue instructions to a set of processing engines within each one of processing clusters.

In at least one embodiment, operation of processing cluster 1514 can be controlled via a pipeline manager 1532 that distributes processing tasks to SIMT parallel processors. In at least one embodiment, pipeline manager 1532 receives instructions from scheduler 1510 of FIG. 15A and manages execution of those instructions via a graphics multiprocessor 1534 and/or a texture unit 1536. In at least one embodiment, graphics multiprocessor 1534 is an exemplary instance of a SIMT parallel processor. However, in at least one embodiment, various types of SIMT parallel processors of differing architectures may be included within processing cluster 1514. In at least one embodiment, one or more instances of graphics multiprocessor 1534 can be included within a processing cluster 1514. In at least one embodiment, graphics multiprocessor 1534 can process data and a data crossbar 1540 can be used to distribute processed data to one of multiple possible destinations, including other shader units. In at least one embodiment, pipeline manager 1532 can facilitate distribution of processed data by specifying destinations for processed data to be distributed via data crossbar 1540.

In at least one embodiment, each graphics multiprocessor 1534 within processing cluster 1514 can include an identical set of functional execution logic (e.g., arithmetic logic units, load-store units, etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 1514 constitute a thread. In at least one embodiment, a set of threads executing across a set of parallel processing engines is a thread group. In at least one embodiment, a thread group executes a common program on different input data. In at least one embodiment, each thread within a thread group can be assigned to a different processing engine within a graphics multiprocessor 1534. In at least one embodiment, a thread group may include fewer threads than a number of processing engines within graphics multiprocessor 1534. In at least one embodiment, when a thread group includes fewer threads than a number of processing engines, one or more of processing engines may be idle during cycles in which that thread group is being processed. In at least one embodiment, a thread group may also include more threads than a number of processing engines within graphics multiprocessor 1534. In at least one embodiment, when a thread group includes more threads than number of processing engines within graphics multiprocessor 1534, processing can be performed over consecutive clock cycles. In at least one embodiment, multiple thread groups can be executed concurrently on a graphics multiprocessor 1534.

In at least one embodiment, graphics multiprocessor 1534 includes an internal cache memory to perform load and store operations. In at least one embodiment, graphics multiprocessor 1534 can forego an internal cache and use a cache memory (e.g., L1 cache 1548) within processing cluster 1514. In at least one embodiment, each graphics multiprocessor 1534 also has access to L2 caches within partition units (e.g., partition units 1520A-1520N of FIG. 15A) that are shared among all processing clusters 1514 and may be used to transfer data between threads. In at least one embodiment, graphics multiprocessor 1534 may also access off-chip global memory, which can include one or more of local parallel processor memory and/or system memory. In at least one embodiment, any memory external to parallel processing unit 1502 may be used as global memory. In at least one embodiment, processing cluster 1514 includes multiple instances of graphics multiprocessor 1534 and can share common instructions and data, which may be stored in L1 cache 1548.

In at least one embodiment, each processing cluster 1514 may include an MMU 1545 (memory management unit) that is configured to map virtual addresses into physical addresses. In at least one embodiment, one or more instances of MMU 1545 may reside within memory interface 1518 of FIG. 15A. In at least one embodiment, MMU 1545 includes a set of page table entries (PTEs) used to map a virtual address to a physical address of a tile and optionally a cache line index. In at least one embodiment, MMU 1545 may include address translation lookaside buffers (TLB) or caches that may reside within graphics multiprocessor 1534 or L1 cache 1548 or processing cluster 1514. In at least one embodiment, a physical address is processed to distribute surface data access locally to allow for efficient request interleaving among partition units. In at least one embodiment, a cache line index may be used to determine whether a request for a cache line is a hit or miss.

In at least one embodiment, a processing cluster 1514 may be configured such that each graphics multiprocessor 1534 is coupled to a texture unit 1536 for performing texture mapping operations, e.g., determining texture sample positions, reading texture data, and filtering texture data. In at least one embodiment, texture data is read from an internal texture L1 cache (not shown) or from an L1 cache within graphics multiprocessor 1534 and is fetched from an L2 cache, local parallel processor memory, or system memory, as needed. In at least one embodiment, each graphics multiprocessor 1534 outputs processed tasks to data crossbar 1540 to provide processed task to another processing cluster 1514 for further processing or to store processed task in an L2 cache, local parallel processor memory, or system memory via memory crossbar 1516. In at least one embodiment, a preROP 1542 (pre-raster operations unit) is configured to receive data from graphics multiprocessor 1534, and direct data to ROP units, which may be located with partition units as described herein (e.g., partition units 1520A-1520N of FIG. 15A). In at least one embodiment, preROP 1542 unit can perform optimizations for color blending, organizing pixel color data, and performing address translations.

Inference and/or training logic 615 are used to perform inferencing and/or training operations associated with one or more embodiments. In at least one embodiment, inference and/or training logic 615 may be used in graphics processing cluster 1514 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

FIG. 15D shows a graphics multiprocessor 1534 according to at least one embodiment. In at least one embodiment, graphics multiprocessor 1534 couples with pipeline manager 1532 of processing cluster 1514. In at least one embodiment, graphics multiprocessor 1534 has an execution pipeline including but not limited to an instruction cache 1552, an instruction unit 1554, an address mapping unit 1556, a register file 1558, one or more general purpose graphics processing unit (GPGPU) cores 1562, and one or more load/store units 1566, where one or more load/store units 1566 can perform load/store operations to load/store instructions corresponding to performing an operation. In at least one embodiment, GPGPU cores 1562 and load/store units 1566 are coupled with cache memory 1572 and shared memory 1570 via a memory and cache interconnect 1568.

In at least one embodiment, instruction cache 1552 receives a stream of instructions to execute from pipeline manager 1532. In at least one embodiment, instructions are cached in instruction cache 1552 and dispatched for execution by an instruction unit 1554. In at least one embodiment, instruction unit 1554 can dispatch instructions as thread groups (e.g., warps, wavefronts, waves), with each thread of thread group assigned to a different execution unit within GPGPU cores 1562. In at least one embodiment, an instruction can access any of a local, shared, or global address space by specifying an address within a unified address space. In at least one embodiment, address mapping unit 1556 can be used to translate addresses in a unified address space into a distinct memory address that can be accessed by load/store units 1566.

In at least one embodiment, register file 1558 provides a set of registers for functional units of graphics multiprocessor 1534. In at least one embodiment, register file 1558 provides temporary storage for operands connected to data paths of functional units (e.g., GPGPU cores 1562, load/store units 1566) of graphics multiprocessor 1534. In at least one embodiment, register file 1558 is divided between each of functional units such that each functional unit is allocated a dedicated portion of register file 1558. In at least one embodiment, register file 1558 is divided between different warps (which may be referred to as wavefronts and/or waves) being executed by graphics multiprocessor 1534.

In at least one embodiment, GPGPU cores 1562 can each include floating point units (FPUs) and/or integer arithmetic logic units (ALUs) that are used to execute instructions of graphics multiprocessor 1534. In at least one embodiment, GPGPU cores 1562 can be similar in architecture or can differ in architecture. In at least one embodiment, a first portion of GPGPU cores 1562 include a single precision FPU and an integer ALU while a second portion of GPGPU cores include a double precision FPU. In at least one embodiment, FPUs can implement IEEE 754-2008 standard floating point arithmetic or enable variable precision floating point arithmetic. In at least one embodiment, graphics multiprocessor 1534 can additionally include one or more fixed function or special function units to perform specific functions such as copy rectangle or pixel blending operations. In at least one embodiment, one or more of GPGPU cores 1562 can also include fixed or special function logic.

In at least one embodiment, GPGPU cores 1562 include SIMD logic capable of performing a single instruction on multiple sets of data. In at least one embodiment, GPGPU cores 1562 can physically execute SIMD4, SIMD8, and SIMD16 instructions and logically execute SIMD1, SIMD2, and SIMD32 instructions. In at least one embodiment, SIMD instructions for GPGPU cores can be generated at compile time by a shader compiler or automatically generated when executing programs written and compiled for single program multiple data (SPMD) or SIMT architectures. In at least one embodiment, multiple threads of a program configured for an SIMT execution model can executed via a single SIMD instruction. For example, in at least one embodiment, eight SIMT threads that perform same or similar operations can be executed in parallel via a single SIMD8 logic unit.

In at least one embodiment, memory, and cache interconnect 1568 is an interconnect network that connects each functional unit of graphics multiprocessor 1534 to register file 1558 and to shared memory 1570. In at least one embodiment, memory and cache interconnect 1568 is a crossbar interconnect that allows load/store unit 1566 to implement load and store operations between shared memory 1570 and register file 1558. In at least one embodiment, register file 1558 can operate at a same frequency as GPGPU cores 1562, thus data transfer between GPGPU cores 1562 and register file 1558 can have very low latency. In at least one embodiment, shared memory 1570 can be used to enable communication between threads that execute on functional units within graphics multiprocessor 1534. In at least one embodiment, cache memory 1572 can be used as a data cache for example, to cache texture data communicated between functional units and texture unit 1536. In at least one embodiment, shared memory 1570 can also be used as a program managed cache. In at least one embodiment, threads executing on GPGPU cores 1562 can programmatically store data within shared memory in addition to automatically cached data that is stored within cache memory 1572.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high-speed interconnect such as PCIe or NVLink). In at least one embodiment, a GPU may be integrated on a package or chip as cores and communicatively coupled to cores over an internal processor bus/interconnect internal to a package or chip. In at least one embodiment, regardless a manner in which a GPU is connected, processor cores may allocate work to such GPU in a form of sequences of commands/instructions contained in a work descriptor. In at least one embodiment, that GPU then uses dedicated circuitry/logic for efficiently processing these commands/instructions.

Inference and/or training logic 615 are used to perform inferencing and/or training operations associated with one or more embodiments. In at least one embodiment, inference and/or training logic 615 may be used in graphics multiprocessor 1534 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

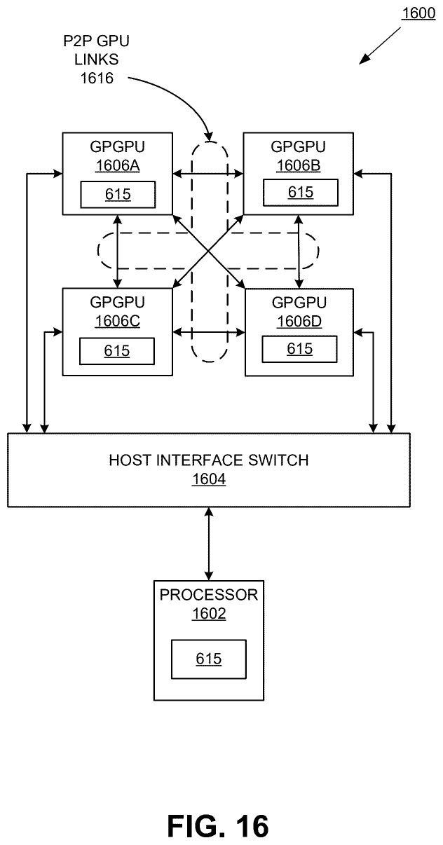

FIG. 16 illustrates a multi-GPU computing system 1600, according to at least one embodiment. In at least one embodiment, multi-GPU computing system 1600 can include a processor 1602 coupled to multiple general purpose graphics processing units (GPGPUs) 1606A-D via a host interface switch 1604. In at least one embodiment, host interface switch 1604 is a PCI express switch device that couples processor 1602 to a PCI express bus over which processor 1602 can communicate with GPGPUs 1606A-D. In at least one embodiment, GPGPUs 1606A-D can interconnect via a set of high-speed point-to-point GPU-to-GPU links 1616. In at least one embodiment, GPU-to-GPU links 1616 connect to each of GPGPUs 1606A-D via a dedicated GPU link. In at least one embodiment, P2P GPU links 1616 enable direct communication between each of GPGPUs 1606A-D without requiring communication over host interface bus 1604 to which processor 1602 is connected. In at least one embodiment, with GPU-to-GPU traffic directed to P2P GPU links 1616, host interface bus 1604 remains available for system memory access or to communicate with other instances of multi-GPU computing system 1600, for example, via one or more network devices. While in at least one embodiment GPGPUs 1606A-D connect to processor 1602 via host interface switch 1604, in at least one embodiment processor 1602 includes direct support for P2P GPU links 1616 and can connect directly to GPGPUs 1606A-D.

Inference and/or training logic 615 are used to perform inferencing and/or training operations associated with one or more embodiments. In at least one embodiment, inference and/or training logic 615 may be used in multi-GPU computing system 1600 for inferencing or predicting operations based, at least in part, on weight parameters calculated using neural network training operations, neural network functions and/or architectures, or neural network use cases described herein.

In at least one embodiment, multi-GPU computing system 1600 includes one or more graphics cores 1300.

Embodiments presented herein can allow for a linear regulator with one or more features for improving the PSRR to identify and correct voltage noise within a circuit.

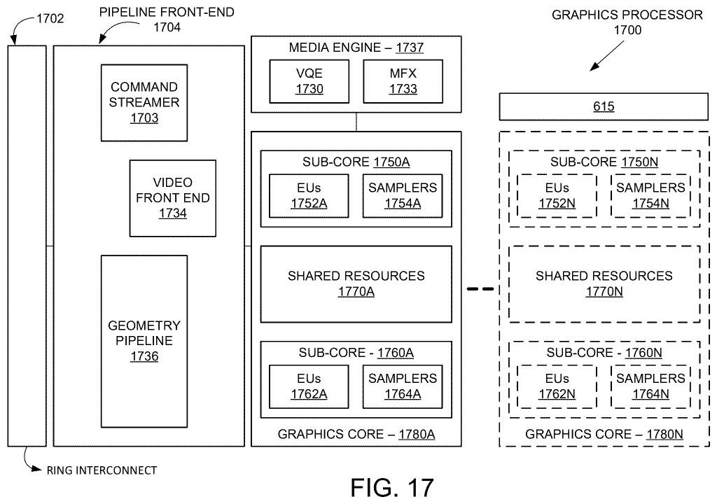

FIG. 17 is a block diagram of a graphics processor 1700, according to at least one embodiment. In at least one embodiment, graphics processor 1700 includes a ring interconnect 1702, a pipeline front-end 1704, a media engine 1737, and graphics core(s) 1780A-1780N. In at least one embodiment, ring interconnect 1702 couples graphics processor 1700 to other processing units, including other graphics processors or one or more general-purpose processor cores. In at least one embodiment, graphics processor 1700 is one of many processors integrated within a multi-core processing system. In at least one embodiment, graphics processor 1700 includes graphics core 1300.

In at least one embodiment, graphics processor 1700 receives batches of commands via ring interconnect 1702. In at least one embodiment, incoming commands are interpreted by a command streamer 1703 in pipeline front-end 1704. In at least one embodiment, graphics processor 1700 includes scalable execution logic to perform 3D geometry processing and media processing via graphics core(s) 1780A-1780N. In at least one embodiment, for 3D geometry processing commands, command streamer 1703 supplies commands to geometry pipeline 1736. In at least one embodiment, for at least some media processing commands, command streamer 1703 supplies commands to a video front end 1734, which couples with media engine 1737. In at least one embodiment, media engine 1737 includes a Video Quality Engine (VQE) 1730 for video and image post-processing and a multi-format encode/decode (MFX) 1733 engine to provide hardware-accelerated media data encoding and decoding. In at least one embodiment, geometry pipeline 1736 and media engine 1737 each generate execution threads for thread execution resources provided by at least one graphics core 1780.

In at least one embodiment, graphics processor 1700 includes scalable thread execution resources featuring graphics core(s) 1780A-1780N (which can be modular and are sometimes referred to as core slices), each having multiple sub-cores 1750A-1750N, 1760A-1760N (sometimes referred to as core sub-slices). In at least one embodiment, graphics processor 1700 can have any number of graphics core(s) 1780A. In at least one embodiment, graphics processor 1700 includes a graphics core 1780A having at least a first sub-core 1750A and a second sub-core 1760A. In at least one embodiment, graphics processor 1700 is a low power processor with a single sub-core (e.g., 1750A). In at least one embodiment, graphics processor 1700 includes multiple graphics core(s) 1780A-1780N, each including a set of first sub-cores 1750A-1750N and a set of second sub-cores 1760A-1760N. In at least one embodiment, each sub-core in first sub-cores 1750A-1750N includes at least a first set of execution units 1752A-1952N and media/texture samplers 1754A-1754N. In at least one embodiment, each sub-core in second sub-cores 1760A-1760N includes at least a second set of execution units 1762A-1962N and samplers 1764A-1764N. In at least one embodiment, each sub-core 1750A-1750N, 1760A-1760N shares a set of shared resources 1770A-1770N. In at least one embodiment, shared resources include shared cache memory and pixel operation logic. In at least one embodiment, graphics processor 1700 includes load/store units in pipeline front-end 1704.

Inference and/or training logic 615 are used to perform inferencing and/or training operations associated with one or more embodiments. In at least one embodiment, inference and/or training logic 615 may be used in graphics processor 1700 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

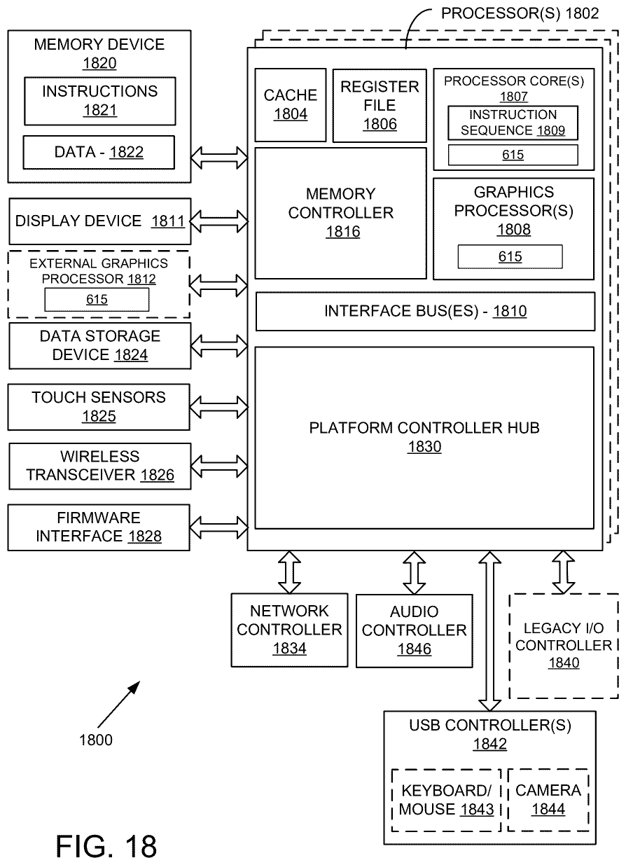

FIG. 18 is a block diagram of a processing system, according to at least one embodiment. In at least one embodiment, system 1800 includes one or more processor(s) 1802 and one or more graphics processor(s) 1808, and may be a single processor desktop system, a multiprocessor workstation system, or a server system having a large number of processor(s) 1802 or processor core(s) 1807. In at least one embodiment, system 1800 is a processing platform incorporated within a system-on-a-chip (SoC) integrated circuit for use in mobile, handheld, or embedded devices. In at least one embodiment, one or more graphics processor(s) 1808 include one or more graphics cores 1300.

In at least one embodiment, system 1800 can include, or be incorporated within a server-based gaming platform, a game console, including a game and media console, a mobile gaming console, a handheld game console, or an online game console. In at least one embodiment, system 1800 is a mobile phone, a smart phone, a tablet computing device or a mobile Internet device. In at least one embodiment, processing system 1800 can also include, couple with, or be integrated within a wearable device, such as a smart watch wearable device, a smart eyewear device, an augmented reality device, or a virtual reality device. In at least one embodiment, processing system 1800 is a television or set top box device having one or more processor(s) 1802 and a graphical interface generated by one or more graphics processor(s) 1808.

In at least one embodiment, one or more processor(s) 1802 each include one or more processor core(s) 1807 to process instructions which, when executed, perform operations for system and user software. In at least one embodiment, each of one or more processor core(s) 1807 is configured to process a specific instruction sequence 1809. In at least one embodiment, instruction sequence 1809 may facilitate Complex Instruction Set Computing (CISC), Reduced Instruction Set Computing (RISC), or computing via a Very Long Instruction Word (VLIW). In at least one embodiment, processor core(s) 1807 may each process a different instruction sequence 1809, which may include instructions to facilitate emulation of other instruction sequences. In at least one embodiment, processor core(s) 1807 may also include other processing devices, such a Digital Signal Processor (DSP).

In at least one embodiment, processor(s) 1802 includes a cache memory (“cache”) 1804. In at least one embodiment, processor(s) 1802 can have a single internal cache or multiple levels of internal cache. In at least one embodiment, cache memory is shared among various components of processor(s) 1802. In at least one embodiment, processor(s) 1802 also uses an external cache (e.g., a Level-3 (L3) cache or Last Level Cache (LLC)) (not shown), which may be shared among processor core(s) 1807 using known cache coherency techniques. In at least one embodiment, a register file 1806 is additionally included in processor(s) 1802, which may include different types of registers for storing different types of data (e.g., integer registers, floating point registers, status registers, and an instruction pointer register). In at least one embodiment, register file 1806 may include general-purpose registers or other registers.

In at least one embodiment, one or more processor(s) 1802 are coupled with one or more interface bus(es) 1810 to transmit communication signals such as address, data, or control signals between processor(s) 1802 and other components in system 1800. In at least one embodiment, interface bus(es) 1810 can be a processor bus, such as a version of a Direct Media Interface (DMI) bus. In at least one embodiment, interface bus(es) 1810 is not limited to a DMI bus, and may include one or more Peripheral Component Interconnect buses (e.g., PCI, PCI Express), memory busses, or other types of interface busses. In at least one embodiment processor(s) 1802 include an integrated memory controller 1816 and a platform controller hub 1830. In at least one embodiment, memory controller 1816 facilitates communication between a memory device and other components of system 1800, while platform controller hub (PCH) 1830 provides connections to I/O devices via a local I/O bus.

In at least one embodiment, a memory device 1820 can be a dynamic random access memory (DRAM) device, a static random access memory (SRAM) device, flash memory device, phase-change memory device, or some other memory device having suitable performance to serve as process memory. In at least one embodiment, memory device 1820 can operate as system memory for system 1800, to store data 1822 and instructions 1821 for use when one or more processor(s) 1802 executes an application or process. In at least one embodiment, memory controller 1816 also couples with an optional external graphics processor 1812, which may communicate with one or more graphics processor(s) 1808 in processor(s) 1802 to perform graphics and media operations. In at least one embodiment, a display device 1811 can connect to processor(s) 1802. In at least one embodiment, display device 1811 can include one or more of an internal display device, as in a mobile electronic device or a laptop device, or an external display device attached via a display interface (e.g., DisplayPort, etc.). In at least one embodiment, display device 1811 can include a head mounted display (HMD) such as a stereoscopic display device for use in virtual reality (VR) applications or augmented reality (AR) applications.

In at least one embodiment, platform controller hub 1830 enables peripherals to connect to memory device 1820 and processor(s) 1802 via a high-speed I/O bus. In at least one embodiment, I/O peripherals include, but are not limited to, an audio controller 1846, a network controller 1834, a firmware interface 1828, a wireless transceiver 1826, touch sensors 1825, a data storage device 1824 (e.g., hard disk drive, flash memory, etc.). In at least one embodiment, data storage device 1824 can connect via a storage interface (e.g., SATA) or via a peripheral bus, such as a Peripheral Component Interconnect bus (e.g., PCI, PCI Express). In at least one embodiment, touch sensors 1825 can include touch screen sensors, pressure sensors, or fingerprint sensors. In at least one embodiment, wireless transceiver 1826 can be a Wi-Fi transceiver, a Bluetooth transceiver, or a mobile network transceiver such as a 3G, 4G, or Long Term Evolution (LTE) transceiver. In at least one embodiment, firmware interface 1828 enables communication with system firmware, and can be, for example, a unified extensible firmware interface (UEFI). In at least one embodiment, network controller 1834 can enable a network connection to a wired network. In at least one embodiment, a high-performance network controller (not shown) couples with interface bus(es) 1810. In at least one embodiment, audio controller 1846 is a multi-channel high definition audio controller. In at least one embodiment, system 1800 includes an optional legacy I/O controller 1840 for coupling legacy (e.g., Personal System 2 (PS/2)) devices to system 1800. In at least one embodiment, platform controller hub 1830 can also connect to one or more Universal Serial Bus (USB) controller(s) 1842 connect input devices, such as keyboard and mouse 1843 combinations, a camera 1844, or other USB input devices.

In at least one embodiment, an instance of memory controller 1816 and platform controller hub 1830 may be integrated into a discreet external graphics processor, such as external graphics processor 1812. In at least one embodiment, platform controller hub 1830 and/or memory controller 1816 may be external to one or more processor(s) 1802. For example, in at least one embodiment, system 1800 can include an external memory controller 1816 and platform controller hub 1830, which may be configured as a memory controller hub and peripheral controller hub within a system chipset that is in communication with processor(s) 1802.

Embodiments presented herein can allow for a linear regulator with one or more features for improving the PSRR to identify and correct voltage noise within a circuit.

At least one embodiment of the disclosure can be described in view of the following clauses:
1. A computer-implemented method comprising:
   receiving, in a network, a request sent by a client to access a server in the network;
   extracting information from a key associated with the request;
   determining, using the extracted information, that the key lacks expected key information previously shared to the server; and
   responsive to determining that the key lacks expected key information, performing at least one action.
2. The computer-implemented method of clause 1, further comprising:
   incrementing a value of a counter for each occurrence of a received request associated with a key lacking the expected key information; and
   responsive to detecting that the counter meets a specified condition, performing at least one remedial action.
3. The computer-implemented method of clause 2, wherein the specified condition includes detecting that the value of the counter exceeds an allowable threshold.
4. The computer-implemented method of clause 1, wherein the action is a remedial action that includes sending a message to a host of the network or rekeying the access key.
5. The computer-implemented method of clause 1, wherein the action includes blocking access to the server for a period of time, or rejecting requests for a period of time.
6. The computer-implemented method of clause 1, wherein the network is a remote direct memory access (RDMA) network.
7. The computer-implemented method of clause 1, further comprising:
   identifying an actor associated with one or more of the requests for access in which the key lacks the expected key information; and
   blocking subsequent requests sent by the actor for at least a period of time.
8. The computer-implemented method of clause 1, further comprising:
   determining that at least one additional field in requests associated with an actor contains suspicious data; and
   blocking additional requests sent by the actor.
9. The computer-implemented method of clause 1, wherein the key is carried in a header of the request.
10. The computer-implemented method of clause 1, further comprising:
   detecting that a second server receives a request from a sender that sent the received request lacking expected key information; and
   instructing the second server to block subsequent requests from the sender.
11. A processor comprising one or more circuits to:
   receive, in a network, a request sent by a client to access a server in the network;
   extract information from a key associated with the request;
   determine, using the extracted information, that the key lacks expected key information previously shared to the server; and
   responsive to detecting that the key lacks expected key information, perform at least one action.
12. The processor of clause 11, wherein the one or more circuits are further to:
   increment a value of a counter for each occurrence of a received request associated with a key lacking the expected key information; and
   responsive to detecting that the counter meets a specified condition, performing at least one remedial action.
13. The processor of clause 11, wherein the one or more circuits are further to:
   identify an actor associated with one or more of the requests for access in which the key lacks the expected key information; and
   block subsequent requests sent by the actor for at least a period of time.
14. The processor of clause 13, wherein the one or more circuits are further to:
   determine that at least one additional field in requests associated with an actor contains suspicious data; and
   block additional requests sent by the actor.
15. The processor of clause 11, wherein the key is carried in a header of the request.
16. The processor of clause 11, wherein the one or more circuits are further to:
   detect that a second server receives a request from a sender that sent the received request lacking expected key information; and
   instruct the second server to block subsequent requests from the sender.
17. A system comprising:
   one or more processors to determine that a server in a network is under a potential attack based on a determination that more than a threshold a number of requests have been received where key information associated with the requests differs from expected key information pre-shared to the server in the network.
18. The system of clause 17, wherein the one or more processors are further to perform at least one remedial action based on the determination that the server in the network is under a potential attack.
19. The system of clause 18, wherein the remedial action includes sending a message to a host of the network, blocking all access to the server for a period of time, or rejecting requests for a period of time.
20. The system of clause 17, wherein the one or more processors are further to:
   identify an actor associated with one or more of the requests for access in which the key lacks the expected key information; and
   block subsequent requests sent by the actor for at least a period of time.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over utilizing a conventional central processing unit (“CPU”) and bus implementation. In at least one embodiment, various modules may also be situated separately or in various combinations of semiconductor platforms per desires of user.

In at least one embodiment, referring back to FIG. 9, computer programs in form of machine-readable executable code or computer control logic algorithms are stored in main memory 904 and/or secondary storage. Computer programs, if executed by one or more processors, enable computer system 900 to perform various functions in accordance with at least one embodiment. In at least one embodiment, main memory 904, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous FIGS. 1-5 are implemented in context of CPU 902, parallel processing system 912, an integrated circuit capable of at least a portion of capabilities of both CPU 902, parallel processing system 912, a chipset (e.g., a group of integrated circuits designed to work and sold as a unit for performing related functions, etc.), and/or any suitable combination of integrated circuit(s).

In at least one embodiment, architecture and/or functionality of various previous FIGS. 1-5 are implemented in context of a general computer system, a circuit board system, a game console system dedicated for entertainment purposes, an application-specific system, and more. In at least one embodiment, computer system 900 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 912 includes, without limitation, a plurality of parallel processing units (“PPUs”) 914 and associated memories 916. In at least one embodiment, PPUs 914 are connected to a host processor or other peripheral devices via an interconnect 918 and a switch 920 or multiplexer. In at least one embodiment, parallel processing system 912 distributes computational tasks across PPUs 914 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 914, although such shared memory may incur performance penalties relative to use of local memory and registers resident to a PPU 914. In at least one embodiment, operation of PPUs 914 is synchronized through use of a command such as_syncthreads( ), wherein all threads in a block (e.g., executed across multiple PPUs 914) to reach a certain point of execution of code before proceeding.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method comprising:
receiving, in a network, a request sent by a client to access a server in the network;
extracting information from a key associated with the request;
determining, using the extracted information, that the key lacks expected key information previously shared to the server; and
responsive to determining that the key lacks expected key information, performing at least one action.

2. The computer-implemented method of claim 1, further comprising:
incrementing a value of a counter for each occurrence of a received request associated with a key lacking the expected key information; and
responsive to detecting that the counter meets a specified condition, performing at least one remedial action.

3. The computer-implemented method of claim 2, wherein the specified condition includes detecting that the value of the counter exceeds an allowable threshold.

4. The computer-implemented method of claim 1, wherein the action is a remedial action that includes sending a message to a host of the network or rekeying the key.

5. The computer-implemented method of claim 1, wherein the action includes blocking access to the server for a period of time, or rejecting requests for a period of time.

6. The computer-implemented method of claim 1, wherein the network is a remote direct memory access (RDMA) network.

7. The computer-implemented method of claim 1, further comprising:
identifying an actor associated with one or more of the requests for access in which the key lacks the expected key information; and
blocking subsequent requests sent by the actor for at least a period of time.

8. The computer-implemented method of claim 1, further comprising:
determining that at least one additional field in requests associated with an actor contains suspicious data; and
blocking additional requests sent by the actor.

9. The computer-implemented method of claim 1, wherein the key is carried in a header of the request.

10. The computer-implemented method of claim 1, further comprising:
detecting that a second server receives a request from a sender that sent the received request lacking expected key information; and
instructing the second server to block subsequent requests from the sender.

11. A processor comprising one or more circuits to:
receive, in a network, a request sent by a client to access a server in the network;
extract information from a key associated with the request;
determine, using the extracted information, that the key lacks expected key information previously shared to the server; and
responsive to detecting that the key lacks expected key information, perform at least one action.

12. The processor of claim 11, wherein the one or more circuits are further to:
increment a value of a counter for each occurrence of a received request associated with a key lacking the expected key information; and
responsive to detecting that the counter meets a specified condition, performing at least one remedial action.

13. The processor of claim 11, wherein the one or more circuits are further to:
identify an actor associated with one or more of the requests for access in which the key lacks the expected key information; and
block subsequent requests sent by the actor for at least a period of time.

14. The processor of claim 13, wherein the one or more circuits are further to:
determine that at least one additional field in requests associated with an actor contains suspicious data; and
block additional requests sent by the actor.

15. The processor of claim 11, wherein the key is carried in a header of the request.

16. The processor of claim 11, wherein the one or more circuits are further to:
detect that a second server receives a request from a sender that sent the received request lacking expected key information; and
instruct the second server to block subsequent requests from the sender.

17. A system comprising:
one or more processors to determine that a server in a network is under a potential attack based on a determination that more than a threshold a number of requests have been received where key information associated with the requests differs from expected key information pre-shared to the server in the network.

18. The system of claim 17, wherein the one or more processors are further to perform at least one remedial action based on the determination that the server in the network is under a potential attack.

19. The system of claim 18, wherein the remedial action includes sending a message to a host of the network, blocking all access to the server for a period of time, or rejecting requests for a period of time.

20. The system of claim 17, wherein the one or more processors are further to:
identify an actor associated with one or more of the requests for access in which the key lacks the expected key information; and
block subsequent requests sent by the actor for at least a period of time.
